(19) United States
(12) Patent Application Publication
(10) Pub. No.: US 2024/0323487 A1
(43) Pub. Date: Sep. 26, 2024

(54) SYSTEMS AND METHODS FOR ORCHESTRATING WORKOUT VIDEO SESSIONS

(71) Applicant: BEACHBODY, LLC, Santa Monica, CA (US)

(72) Inventors: Bryan Tyler Downing, Seattle, WA (US); Blake C. Visin, Valencia, CA (US); Sheri Linn Green, Newbury Park, CA (US); Jese Emmanuel Rodriquez, Santiago de los Caballeros (DO); Victor Hugo Afonso de Alencar, Sao Paulo (BR)

(21) Appl. No.: 18/588,410

(22) Filed: Feb. 27, 2024

Related U.S. Application Data
(63) Continuation of application No. 18/119,763, filed on Mar. 9, 2023.
Application No. 18/119,763 is a continuation of application No. 17/747,683, filed on May 18, 2022, now abandoned.
(60) Provisional application No. 63/190,188, filed on May 18, 2021.

(51) Int. Cl. H04N 21/462; G06V 10/764; G06V 20/40; G06V 20/52; G06V 40/20; H04N 21/466; H04N 21/482

(52) U.S. Cl. CPC H04N 21/462; G06V 10/764; G06V 20/41; G06V 20/52; G06V 40/20; H04N 21/466; H04N 21/482

(57) ABSTRACT

Disclosed are example embodiments of systems and methods for displaying a workout session having a virtual wall of live streams. The system includes one or more processors and a memory coupled to the one or more processors. The memory has instructions that, when executed, cause the one or more processor to determine whether a plurality of participants are eligible to be presented on a wall of live streams of a live workout session based at least on an eligibility criteria. The memory also has instructions that, when executed, cause the one or more processor to display a video stream of a first participant from the plurality of participants on the wall of live streams based on the determination.

### CROSS-REFERENCE TO RELATED APPLICATIONS

The present application is a continuation of U.S. patent application Ser. No. 18/119,763, filed Mar. 9, 2023, which is a continuation of U.S. patent application Ser. No. 17/747,683, filed May 18, 2022, now abandoned, which claims priority to U.S. Provisional Patent Application No. 63/190,188, filed May 18, 2021, the disclosures of which are hereby incorporated by reference in their entireties.

### TECHNICAL FIELD

The disclosure relates generally to the field of exercise systems, and specifically and not by way of limitation, some embodiments are related to exercise systems including video.

### BACKGROUND

Many people begin fitness regimes only to later abandon the effort. Unfortunately, for many people it can be very difficult to maintain motivation to continue these fitness regimes. Work, children, spouses, schooling, and other activities may seem to get in the way of a person's fitness goals. However, fitness goals can be a very important aspect of maintaining health and hopefully living a long life. Accordingly, the importance of working out cannot be understated. Thus, a need exists to help keep people motivated to continue the fitness routine so that they may reach their goals and hopefully remain healthy and active. One way to help maintain motivation is to exercise within a workout community where members of that workout community may keep each other motivated.

### SUMMARY

In one example implementation, an embodiment includes a wall of live streams that may include a plurality of live streams of participants of a workout session or members of a workout community that have signed up to be exhibited on the wall of live streams.

Disclosed are example embodiments of a method displaying a workout session. The method including determining whether a plurality of participants are eligible to be presented on a wall of live streams of a live workout session based at least on an eligibility criteria. Additionally, the method including displaying a video stream of a first participant from the plurality of participants on the wall of live streams based on the determination.

Disclosed are example embodiments of a system for displaying a workout session having a virtual wall of live streams. The system including one or more processors and a memory coupled to the one or more processors. The memory has instructions that when executed cause the one or more processor to determine whether a plurality of participants are eligible to be presented on a wall of live streams of a live workout session based at least on an eligibility criteria. Additionally, the memory has instructions that when executed cause the one or more processor to display a video stream of a first participant from the plurality of participants on the wall of live streams based on the determination.

The features and advantages described in the specification are not all-inclusive. In particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the disclosed subject matter.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIG. 1 illustrates a workout session having a wall of live streams in accordance with some embodiments of the present disclosure.

FIGS. 2A-2B illustrate graphical user interfaces of an application for moderating participants on the wall of live streams in accordance with some embodiments of the present disclosure.

FIGS. 3A-3B also illustrate graphical user interfaces of an application for moderating participants on the wall of live streams in accordance with some embodiments of the present disclosure.

FIGS. 4-8 illustrate graphical user interfaces of an application for moderating participants on the wall of live streams in accordance with some embodiments of the present disclosure.

FIGS. 9-10 illustrate graphical user interfaces of an application for moderating participants and configuring the layout of the wall of live streams in accordance with some embodiments of the present disclosure.

FIGS. 11-22 illustrate workflow diagrams of various backend services used to implement the wall of live streams shown in FIG. 1 and GUIs shown in FIGS. 2-10 in accordance with some embodiments of the present disclosure.

FIG. 23 illustrate a graphical user interface of an application for moderating participants in various virtual room in accordance with some embodiments of the present disclosure.

FIG. 24-27 illustrate graphical user interfaces from a participant's perspective in accordance with some embodiments of the present disclosure.

FIG. 28 illustrates an example of a number of people working out within a workout community in accordance with some embodiments of the present disclosure.

FIG. 29 illustrates another example of a number of people working out within a workout community in accordance with some embodiments of the present disclosure.

FIG. 30 illustrates an example of joining a stage in accordance with some embodiments of the present disclosure.

FIGS. 31A-31B illustrate generating display view links in accordance with some embodiments of the present disclosure.

FIGS. 32A-32B illustrate generating BODcast links in accordance with some embodiments of the present disclosure.

FIGS. 33A-33C illustrate example music players in accordance with some embodiments of the present disclosure.

FIG. 34 illustrates example display and configure options screen in accordance with some embodiments of the present disclosure.

FIG. 35 illustrate example screen for connection buttons in a class in accordance with some embodiments of the present disclosure.

FIG. 36 illustrate example screen for a class simulator in accordance with some embodiments of the present disclosure.

FIG. 37 illustrate example screen for using the music player and class simulator in accordance with some embodiments of the present disclosure.

FIG. 38 illustrate example screen for quality checks in accordance with some embodiments of the present disclosure.

FIG. 39 illustrate example of a workout using dumbbells in accordance with some embodiments of the present disclosure.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

### Overview

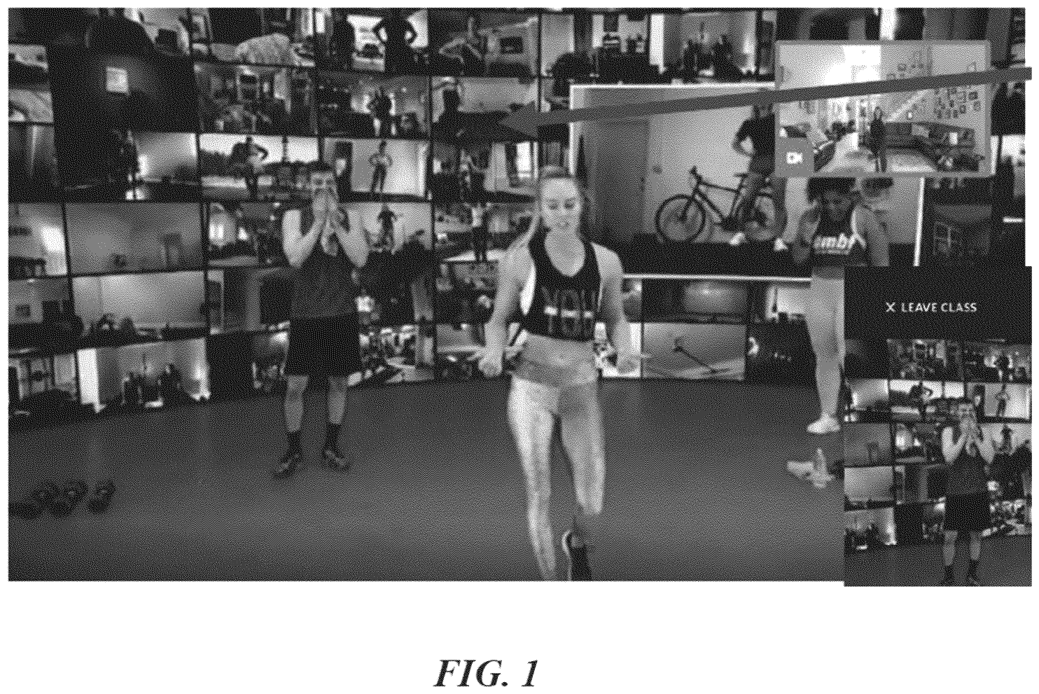

FIG. 1 illustrates a workout session having a wall of live streams superimposed in the background of the workout session. The workout session can be a live workout session or a pre-recorded session. In some embodiments, the wall of live streams (hereinafter referred to as “BODCast wall”) comprises of a plurality of live streams of participants of the workout session or members of the workout community that signed up to be exhibited on the BODCast wall.

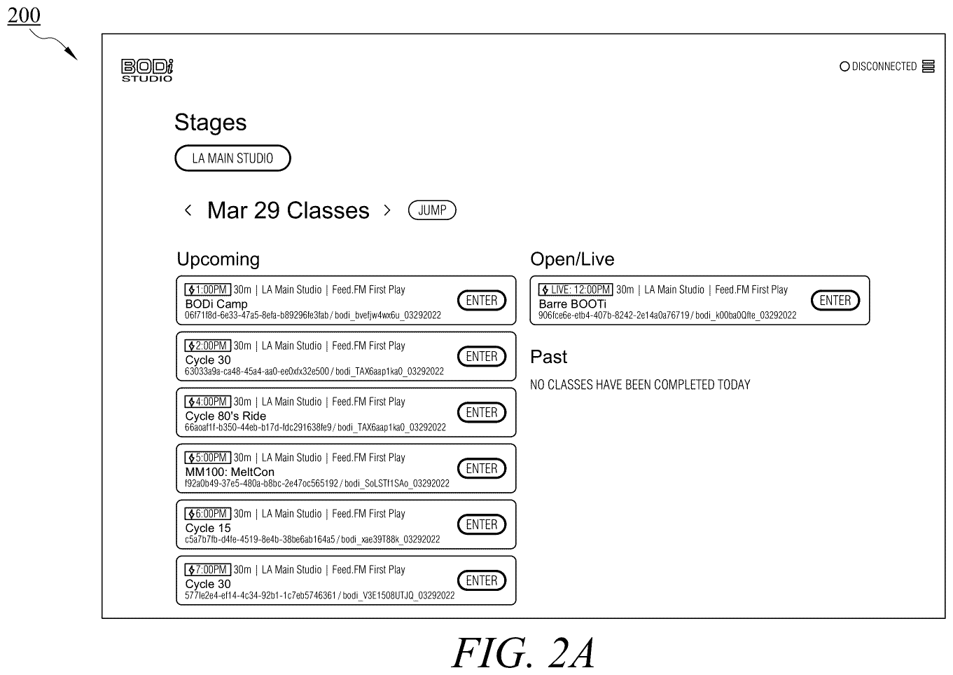

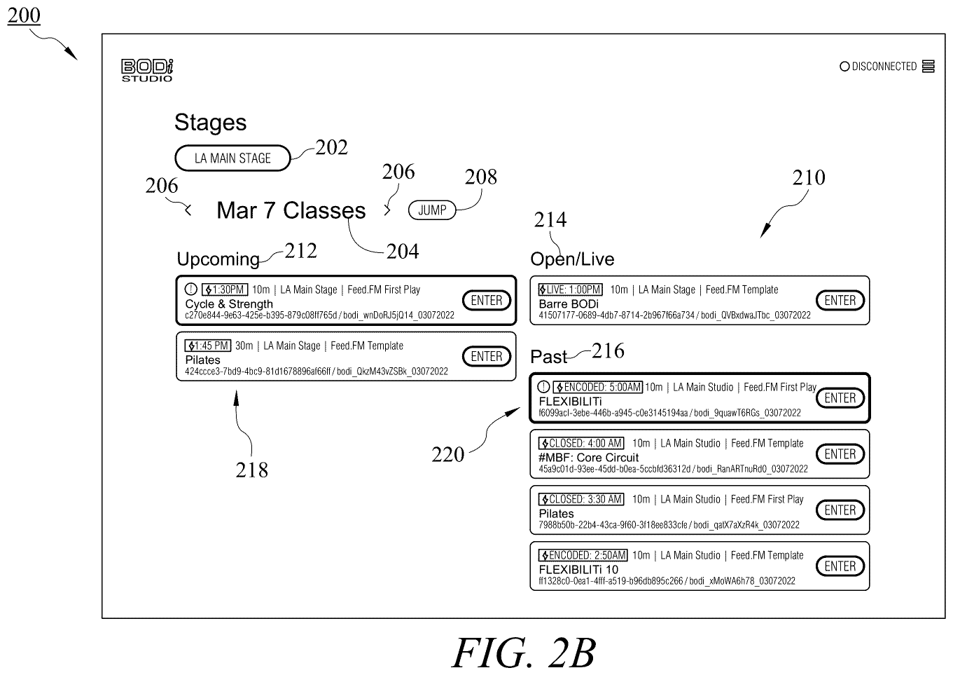

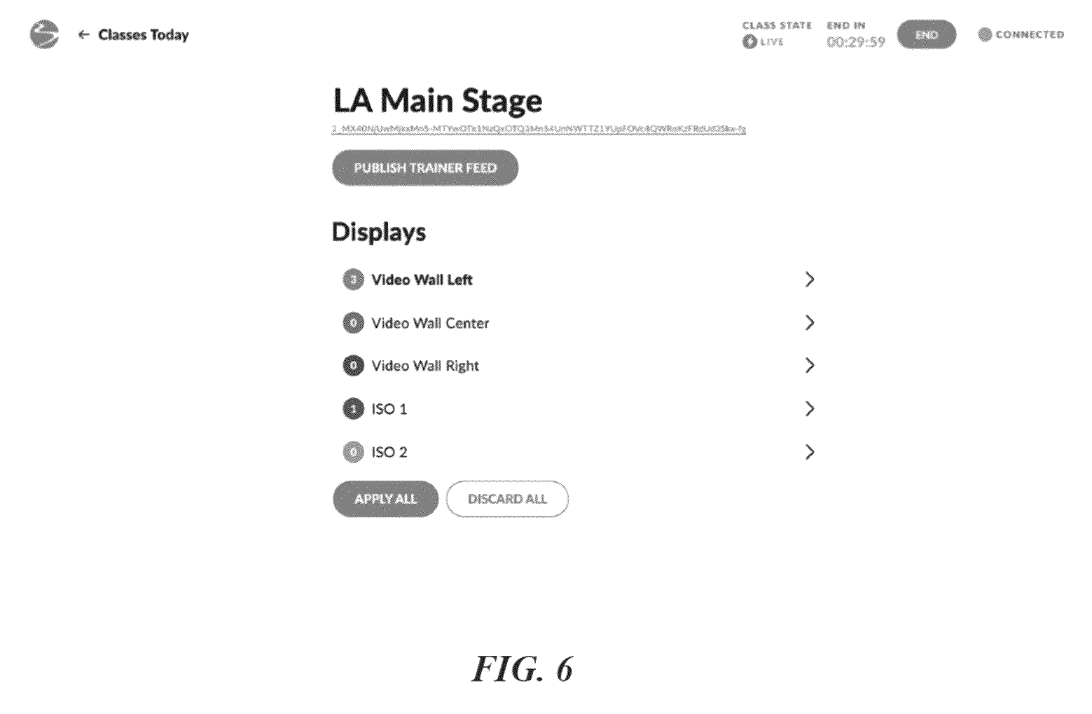

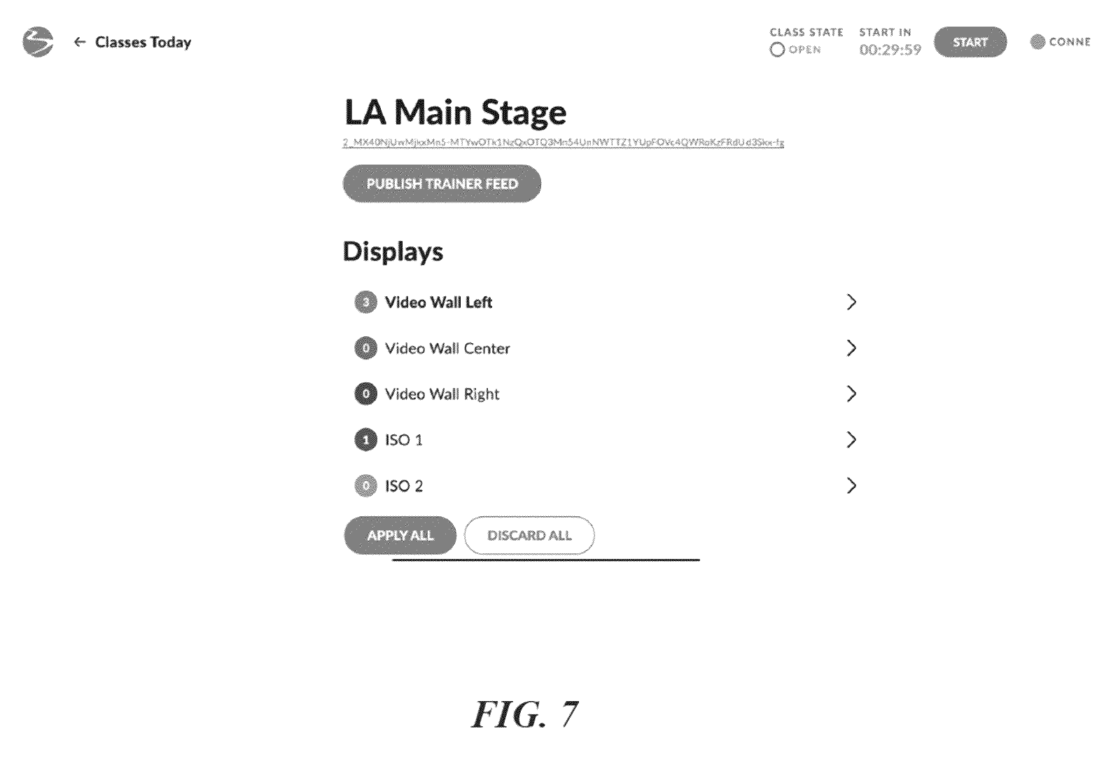

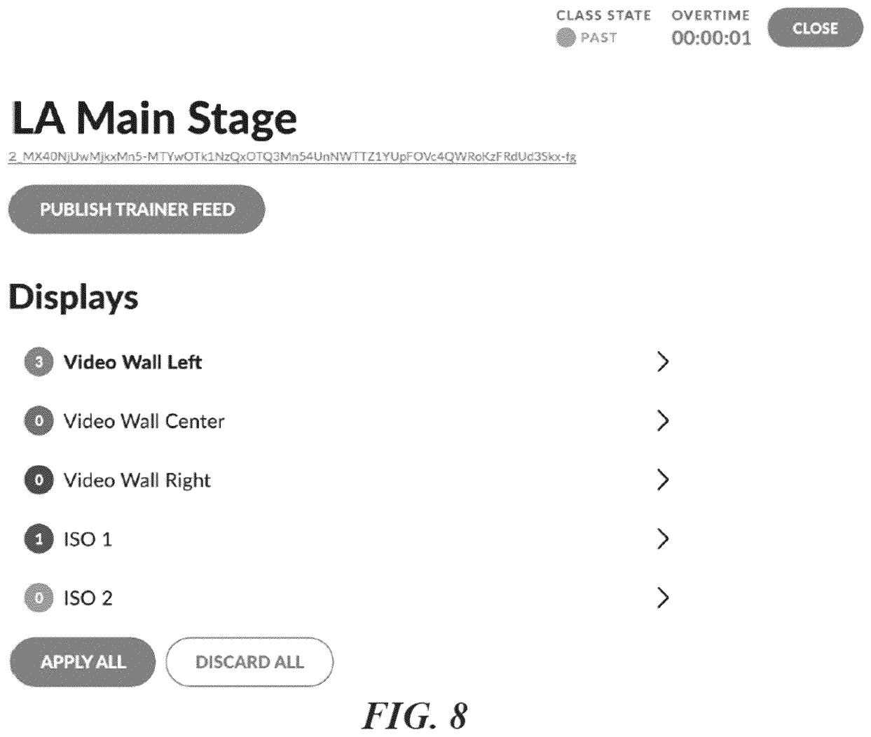

Streams on the BODCast wall can be moderated by a moderator using a moderator tool (see FIGS. 2-9). The moderator can use one or more BODCast eligibility criteria to determine whether a member of the workout community is eligible to be exhibited on the BODCast wall. The BODCast criteria can be factors such as, but not limited to, workout experience, previous workout score (e.g., score for successfully meeting required heart rate zones), community score (e.g., favorability ranking/score by community members, trust score), current heart rate zone performance, appropriate attire, and appropriate background (e.g., inappropriate poster on the wall). The moderator can add a member to or remove a member from the BODCast wall based on one or more of the BODCast criteria. In some embodiments, a moderating module can be configured to automatically add a member to or remove a member from the BODCast wall based on one or more of the BODCast criteria. The moderating module includes one or more processors, a memory, and instructions, which when executed by the one or more processors, cause the one or more processors to modify the contents of the BODCast wall based on one or more of the BODCast criteria. The moderating module can also modify the content of the BODCast wall randomly. For example, even after filtering out ineligible members using the BODCast criteria, there can be more eligible members than available streaming space on the BODCast wall. Thus, the content of the wall (i.e., number of streams) and be randomly populated.

FIGS. 2-10 are images of a moderator tool 200 in accordance with some embodiments of the present invention. Moderator tool 200 can be an application or a web-based application configured to allow a moderator to manage the BODCast wall. Moderator tool 200 can show all eligible members that can be added to the BODCast wall. Using tool 200, the moderator can remove one or more members from the BODCast wall. In this way, the content of the BODCast wall can be controlled to ensure high quality and appropriate streaming content.

FIG. 2A illustrates an example of a control screen 200 of moderator tool that enables the moderator to view past, current, and upcoming workout sessions. The moderator can enter any of the workout sessions to chat with the participants of each class and/or to create or modify a BODCast wall. The moderator can create a BODCast wall in advance and also schedule it for live broadcasting once the class is live. Participants can be active participants of a workout session or an observer.

FIG. 2B further illustrates an example of the control screen 200 of moderator tool. On the home page you may see a blue pill link 202 at the top that link you to a stage, without attaching to a specific class. In an example embodiment, the blue pill link 202 at the top that link you to a stage may be used for more general testing, like display layout testing, moderator tools, and populate/clear displays. In an example embodiment, the blue pill links 202 will not give you access to the Class Simulator tool or populate class-specific Music Player data.

In an example embodiment, below the stage links, there is a date selector 204, with arrows 206 to toggle and a Jump 208 feature to use a calendar for date navigation. The bottom section 210 shows Class Tiles, which are broken up into three sections; Upcoming 212 (classes that are scheduled but have not opened to the public to join), Live/Open 214 (classes where members can join into the lobby before a class, and currently running Live classes), and Past 216 (any classes that have been ended, closed, and/or encoded).

In an example embodiment, data provided in the class tile 218 may include, but is not limited to, scheduled time (hover to see UTC time), Duration, Stage, and Playlist type; Class Name; Class ID and Video ID; both are displayed as blue click-to-copy links; and Enter button brings you to the stage using that class data. In an example embodiment, in the event that a class is scheduled to use a First Play playlist, but the playlist data cannot be found in the FecdFM environment, an example system may show a UI warning as a red border outline and an exclamation mark next to the class time 220.

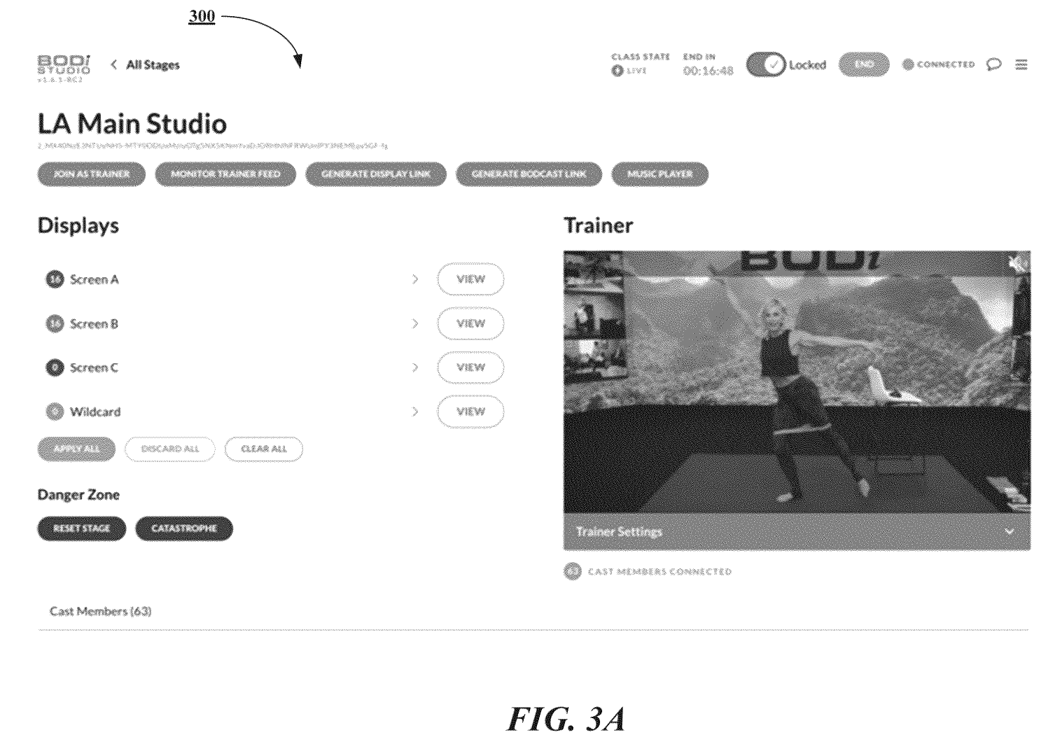

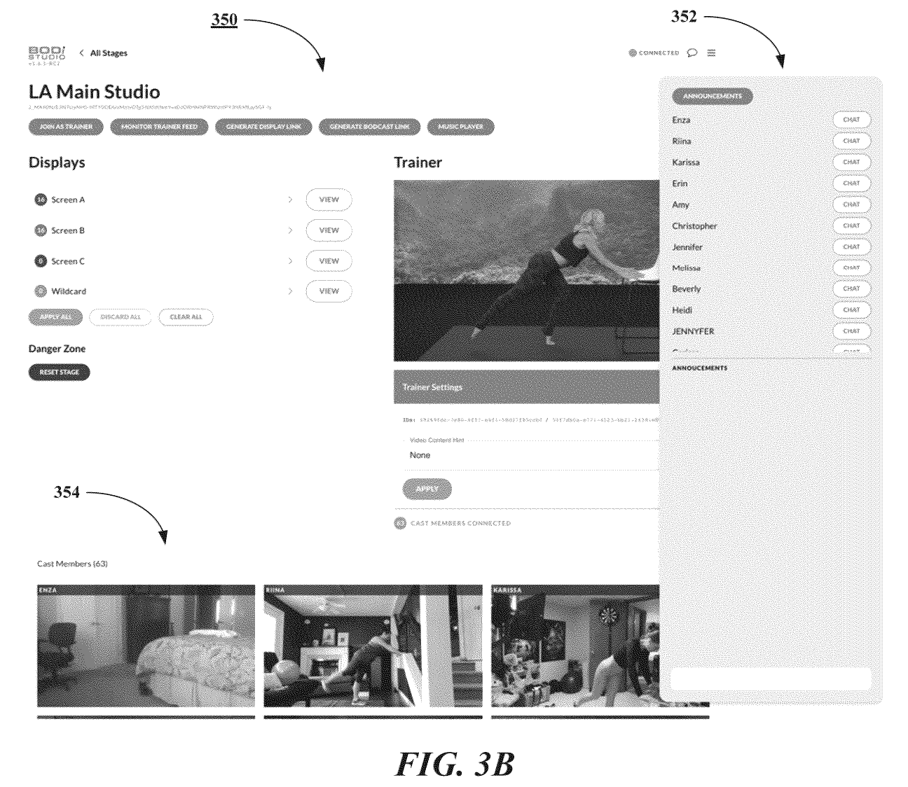

FIGS. 3A-3B illustrate control screens 300, 350 of moderator tool that enables the moderator to view the number of participants on each wall (e.g., left, center, and right wall). In some embodiments, the BODCast wall can have a plurality of portions such as, but not limited to, left, right, center, upper left, upper right, upper center, lower left, lower right, and lower center. Although not visually shown, moderator tool also enables the moderator to schedule the rotation or shuffling of participants in and out of the BODCast wall. The BODCast streams rotation/shuffling can be based on one or more criteria such as, but not limited to, community score, workout statistics (e.g., current heart rate zone, maximum heart rate), and workout score of previous sessions. FIG. 3B illustrates an expanded view 350 of the control screen 300 of moderator tool. The expanded view 350 includes announcements 352 with a chat feature and a view 354 of several cast members.

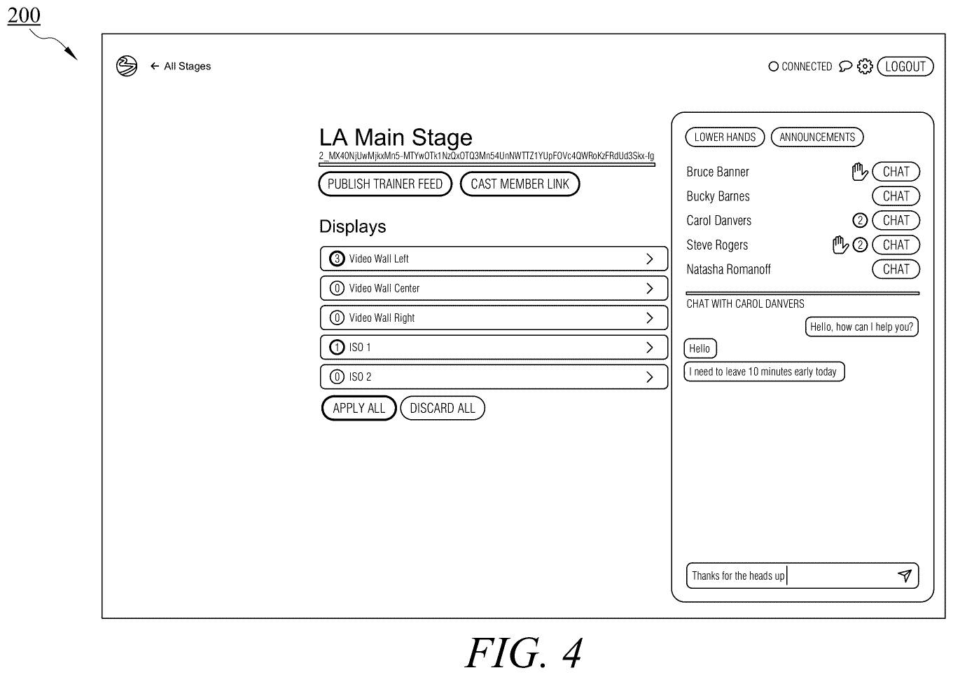

FIG. 4 illustrates an example control screen 400 of another example moderator tool that enables the moderator to enable a chat session with one or more of the participants of a particular workout session. The chat session can be a private chat session between a participant and the moderator. Alternatively, the chat room can be a chat room all participants of the particular workout session.

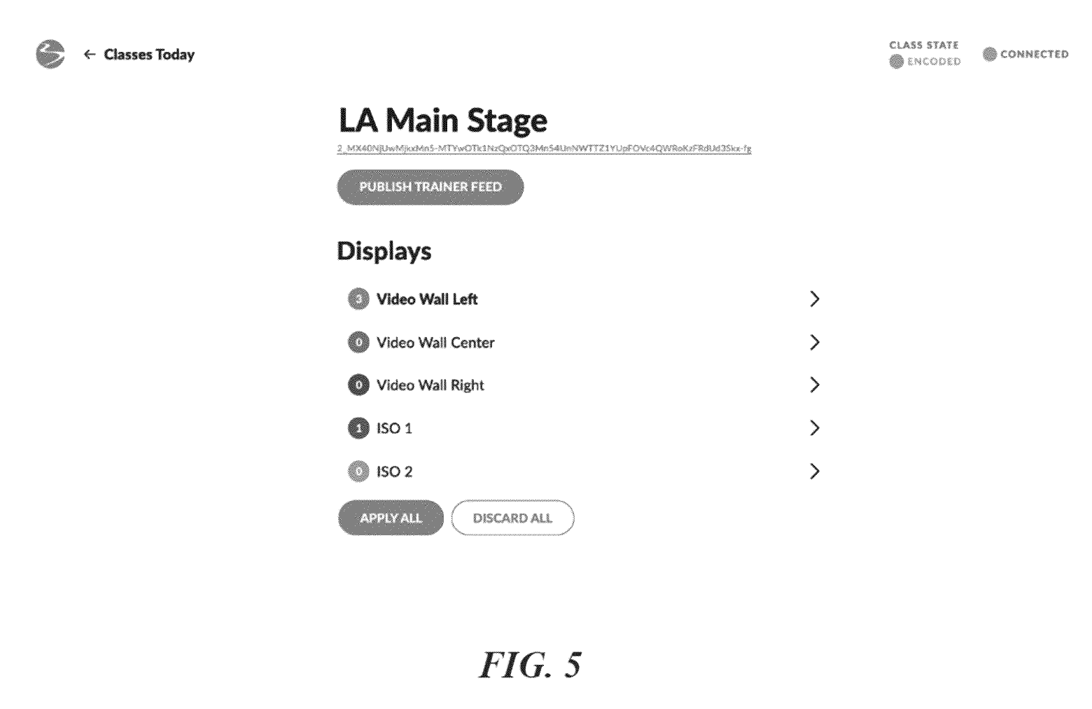

FIGS. 5-8 illustrate control screens of moderator tool 200 that enable the moderator to enter a workout session and view the start time, elapsed time, overtime of the workout session. The moderator can start, modify, and/or end the BODCast wall at anytime.

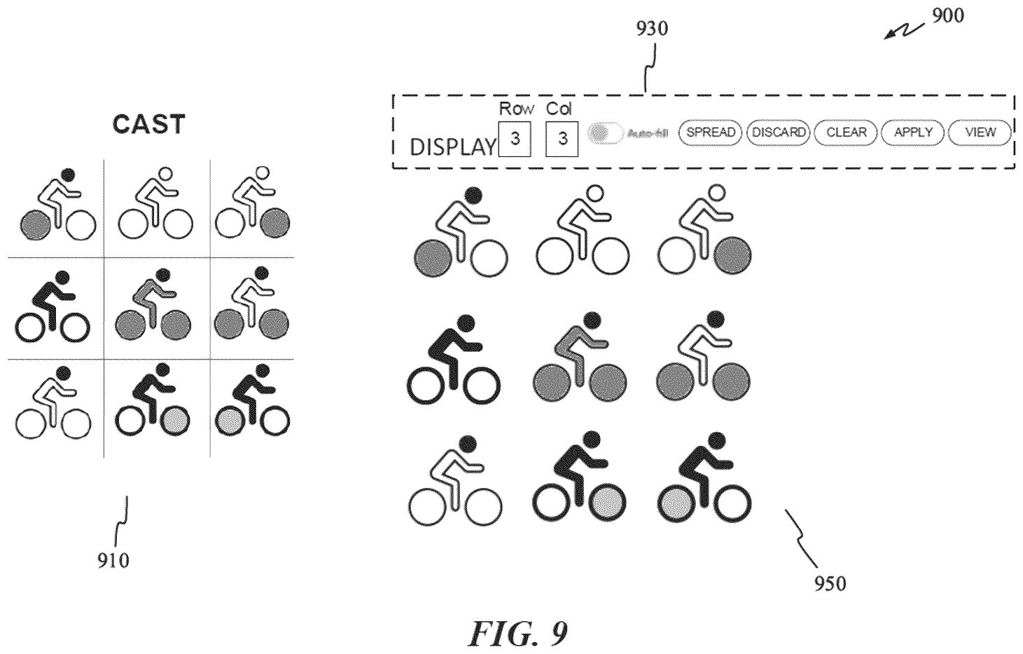

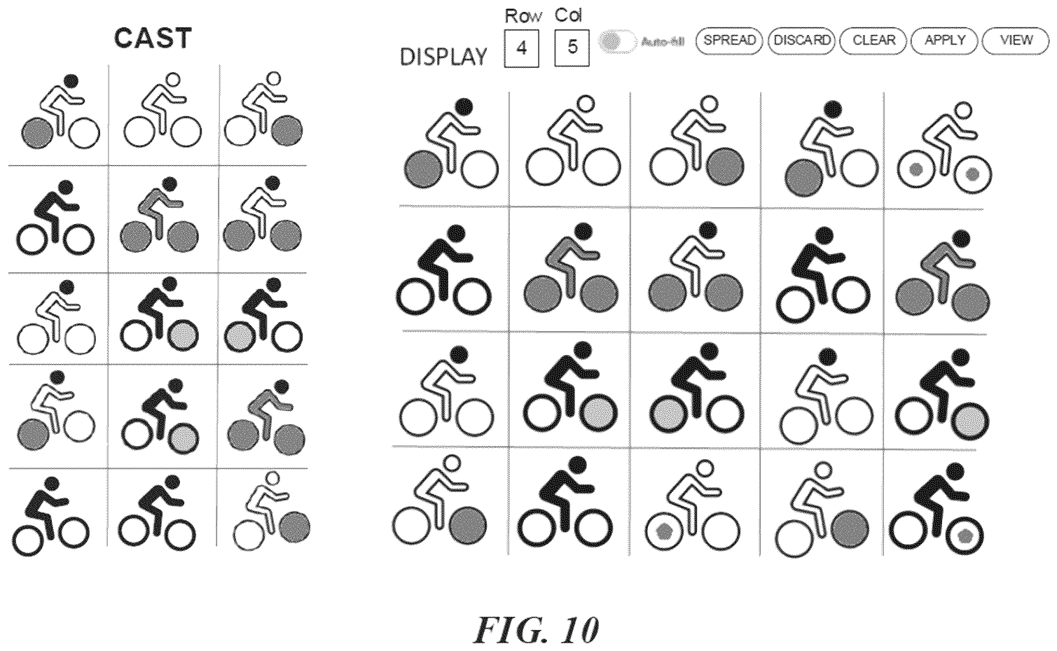

FIG. 9 illustrates a control panel 900 of moderator tool 200 in accordance with some embodiments of the present disclosure. Panel 900 includes a cast view portion 910, a control portion 930, and a BODCast preview portion 950. Using control portion 930, the moderator can define the size of the BODCast wall. For example, the BODCast wall can be a 3×3, which means it will display 9 participants in a 3×3 configuration. The BODCast wall can have any dimensions such as 1×10, 5×15, 7×20, etc. For instance, FIG. 10 shows a 4×5 BODCast wall. The moderator can design the layout of the BODCast wall in a grid or in any other layout (e.g., circular, triangular). The moderator can select one or more participants from cast portion 910 to populate preview portion 950. For example, the moderator can drag and drop a participant to any location on preview portion 950.

Once preview portion 950 is populated and the layout is desirable, the moderator can activate the view and make it live. This means preview portion 950 will appear as a BODCast wall on a live stream workout session. Once the BODCast wall is live, the moderator can make any changes to preview portion 950 and then apply the changes as desired.

In some embodiments, the moderator can select any of the streams of the BODCast wall to immediately remove it from the BODCast wall. In this way, the moderator can control the quality of the streaming content.

The moderation of the BODCast wall can also be done using a moderation module (not shown), which can be AI-enabled to detect inappropriate attire, languages, and/or background of a stream. The moderation can include algorithms (e.g., instructions) configured to cause one or more processor to populate the BODCast wall with streams based one or more eligibility criteria, which can be one or more of the participants' characteristics, current performance metrics (e.g., current heart rate zone, maximum heart rate), past performance metrics, number of followers in the workout community, community score, and workout attire. For instance, the moderation module can analyze each participant in the cast view portion 910 to determine the participant's eligibility criteria. Each participant can then be assigned an exhibition score based on the eligibility criteria. For example, a participant can be given a high exhibition score based on number of workout session he/she has successfully completed. The exhibition score can be adjusted based on how many successful heart-zone targets the participants have performed. In another instance, the exhibition score can be adjusted based on the community score of the participant. Each participant can have an overall/total exhibition score based on the totality of the eligibility criteria.

In some embodiments, the moderation module can automatically populate and modify the BODCast wall based at least on the overall exhibition score of each participant. The moderation module can create a list of exhibition priority based on the overall exhibition score. The BODCast wall can be populated based on the list of exhibition priority.

In some embodiments, the moderation module can continuously analyze each stream of the BODCast wall to look for inappropriate content such as inappropriate attire, background image(s), and/or inappropriate behavior (e.g., physical gestures, incorrect exercise movements). The moderation module can include one or more pre-trained AI engines configured to identify and classify attire, background image(s), and behavior. Based on the one or more AI engines classifications, the moderation module can remove a participant from the BODCast wall. For example, during a workout session, one of the participants on the BODCast wall removes his shirt. In this example, the AI engine will recognize that the participant is shirtless and therefore violates one of the eligibility factors of the BODCast wall. As a result, the AI engine will immediate remove the participant from the BODCast wall and replaces him with another participant in the waiting room.

The moderation module can also analyze the stream of each participant in the waiting room, which can be a virtual waiting room that queue up participants for the BODCast wall. The waiting room also provide notice to the participants that there video session will soon be exhibited on the BODCast wall. In this way, the participants can pay attend and perhaps improve their performance.

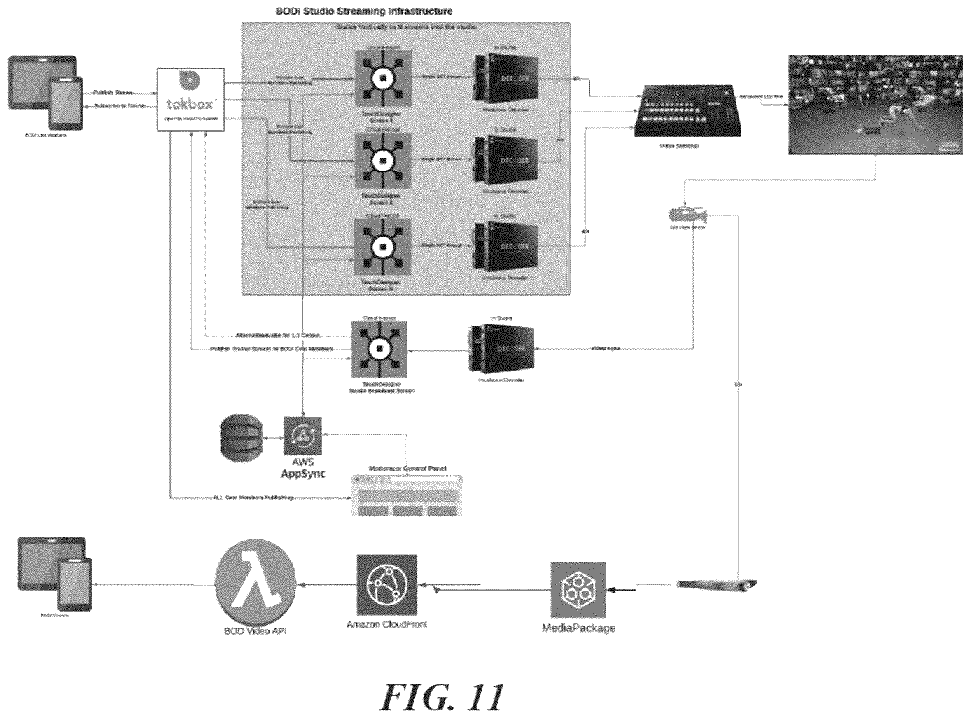

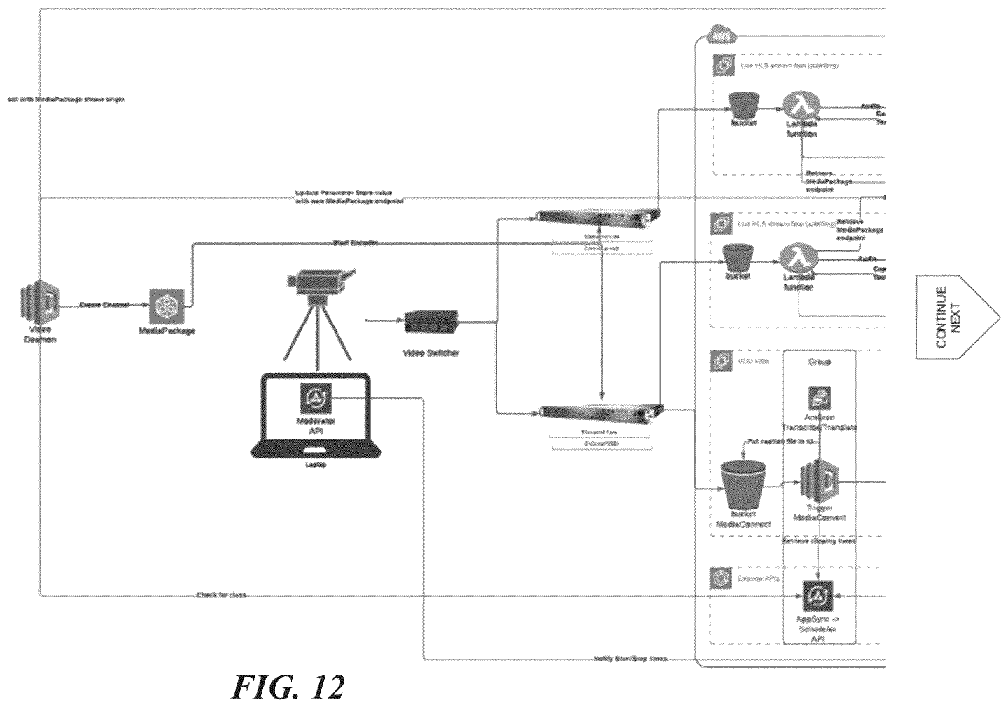

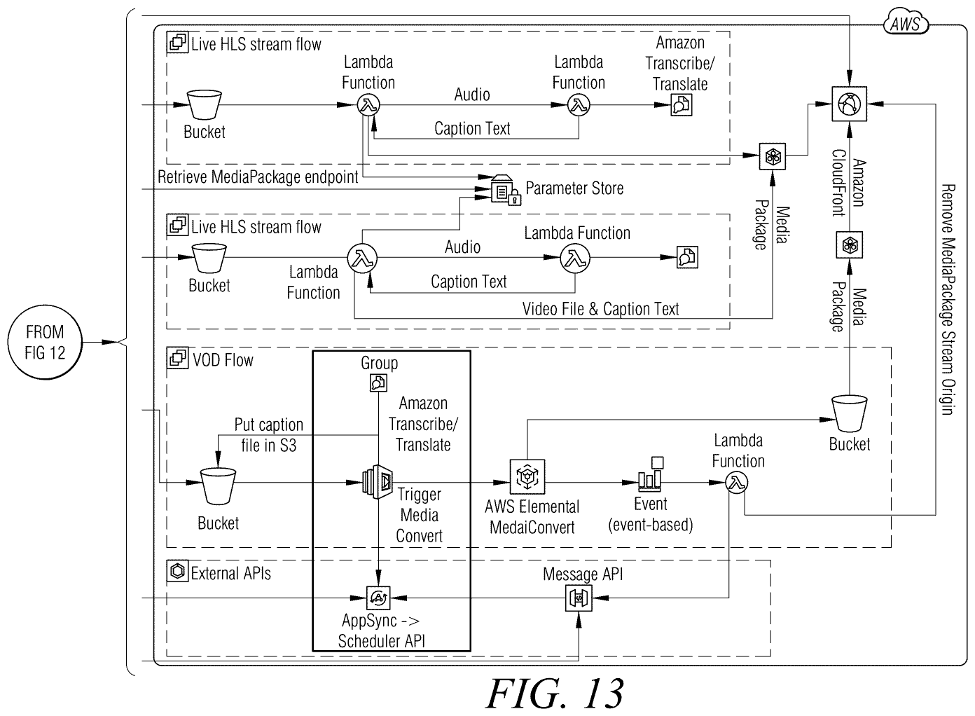

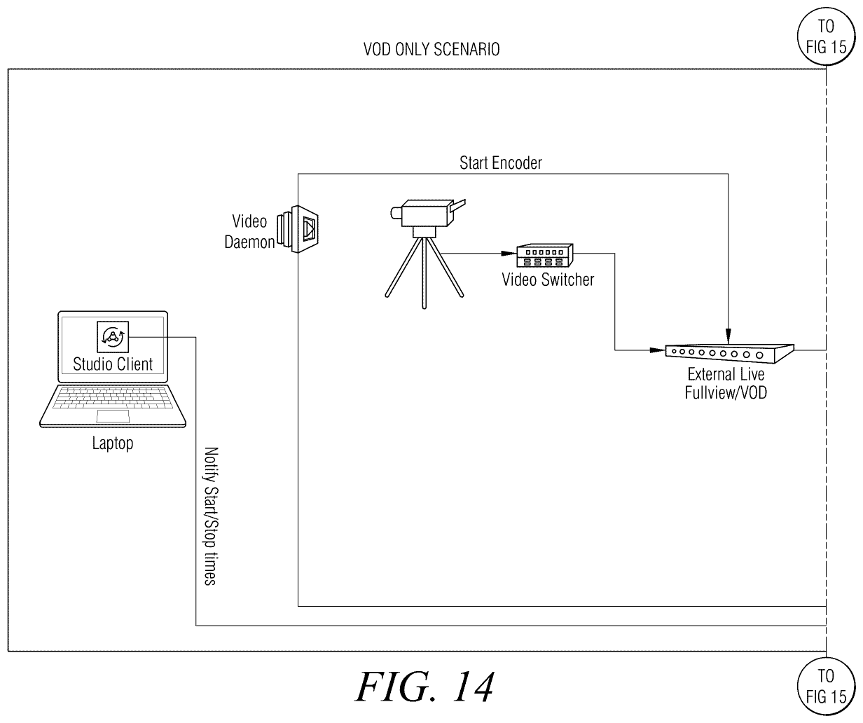

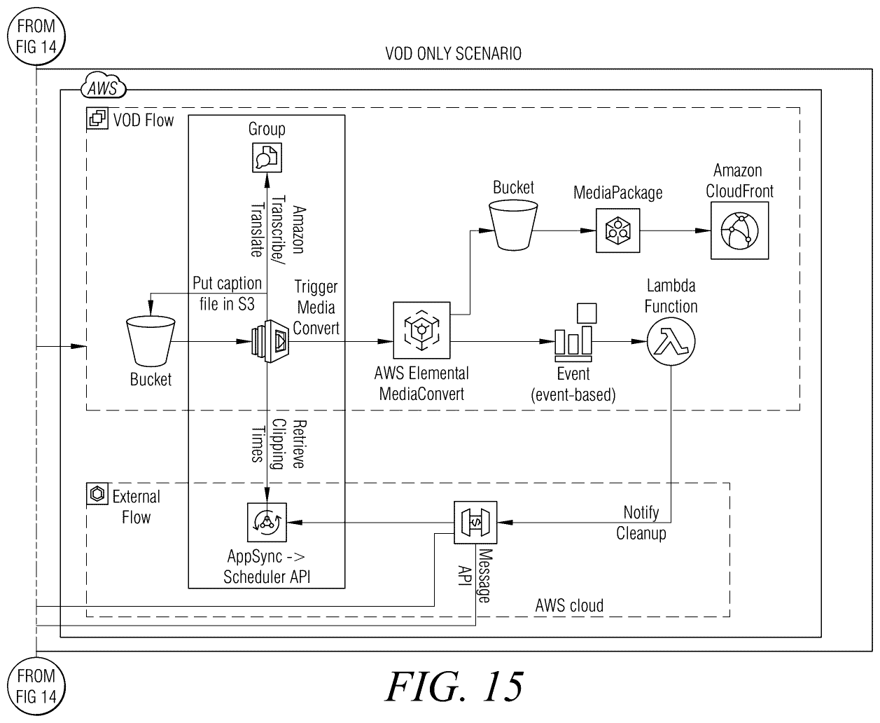

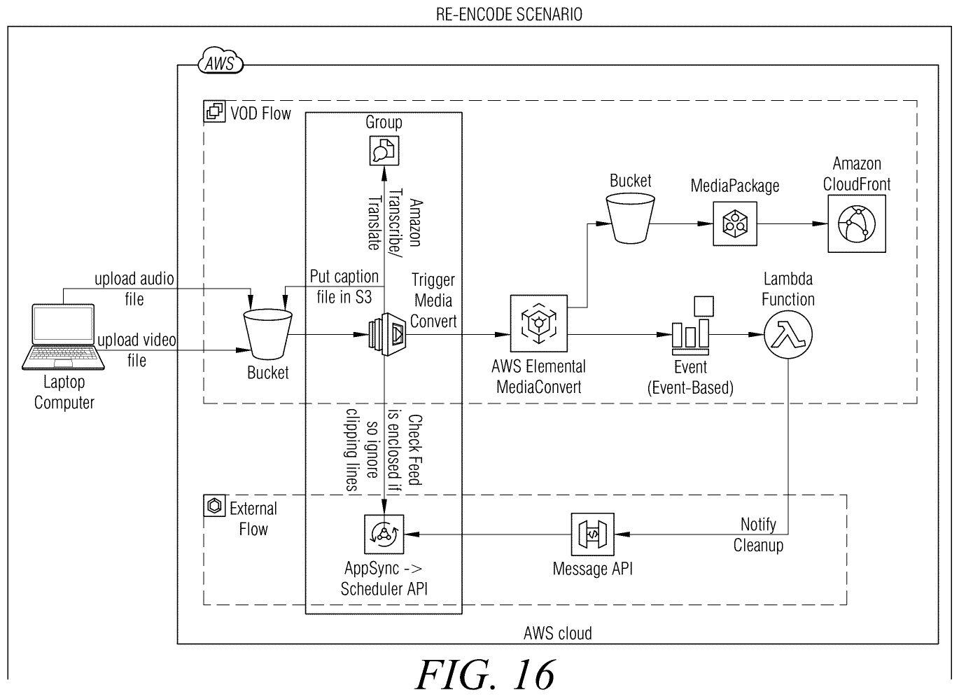

FIGS. 11-16 illustrate the system architectures and workflows of various backend services used to implement the BODCast wall shown in FIG. 1, the moderation tool and screens show in FIGS. 2-8, and/or the moderation control panel or tool shown in FIGS. 9 and 10.

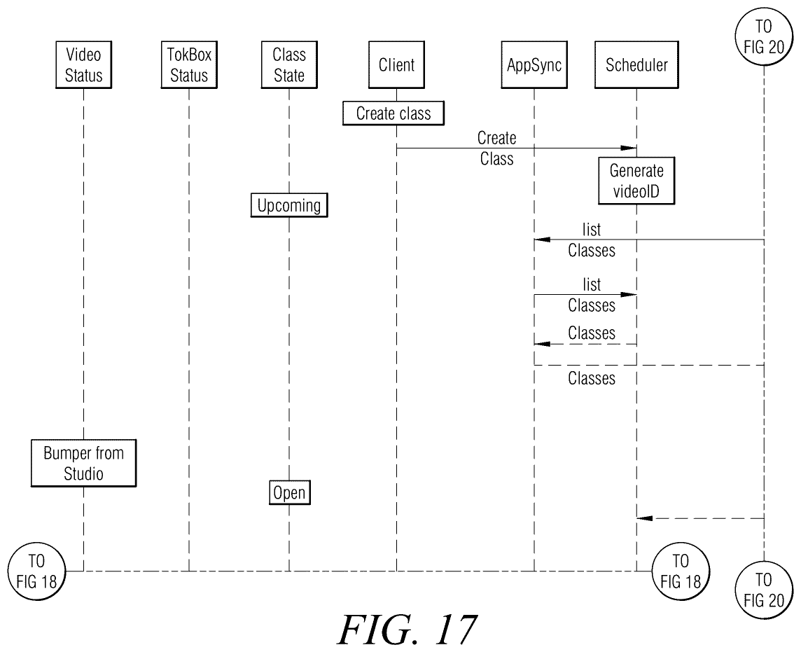

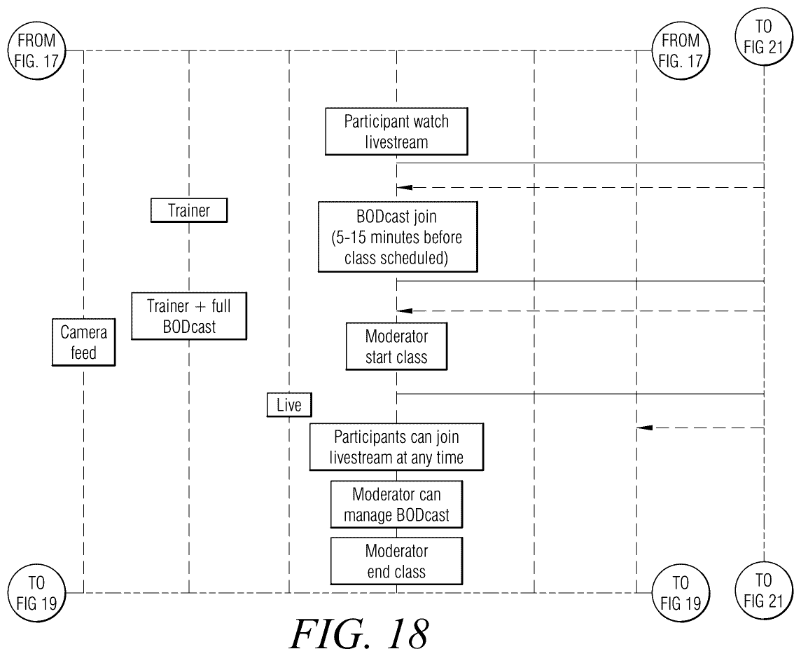

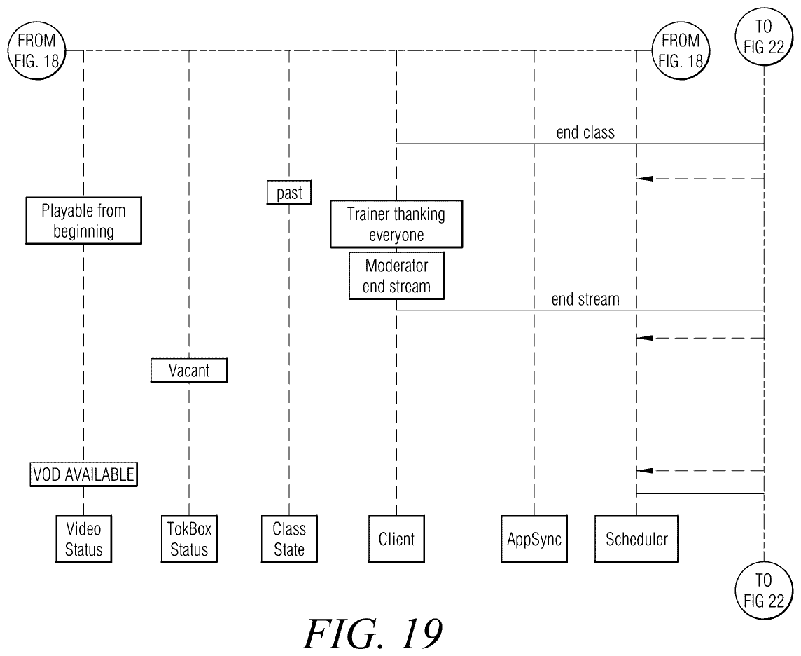

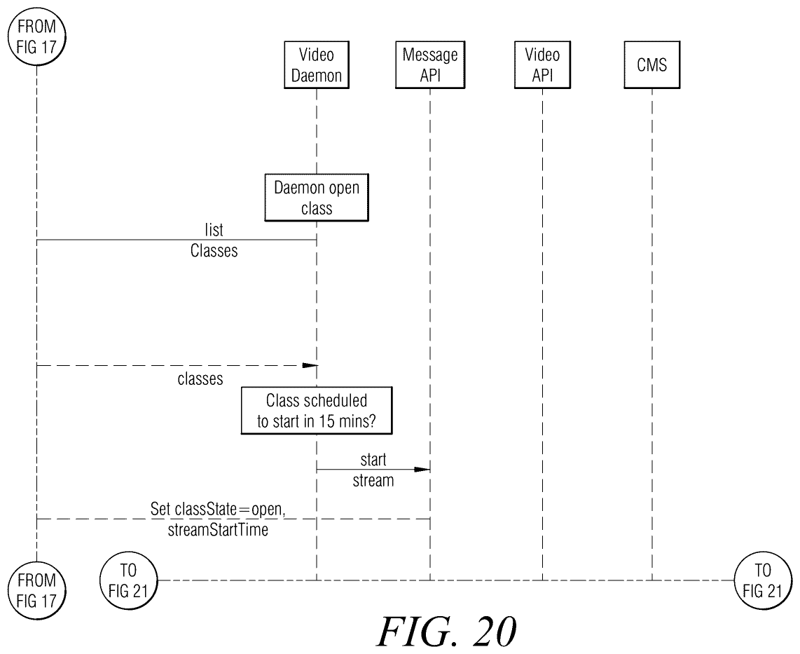

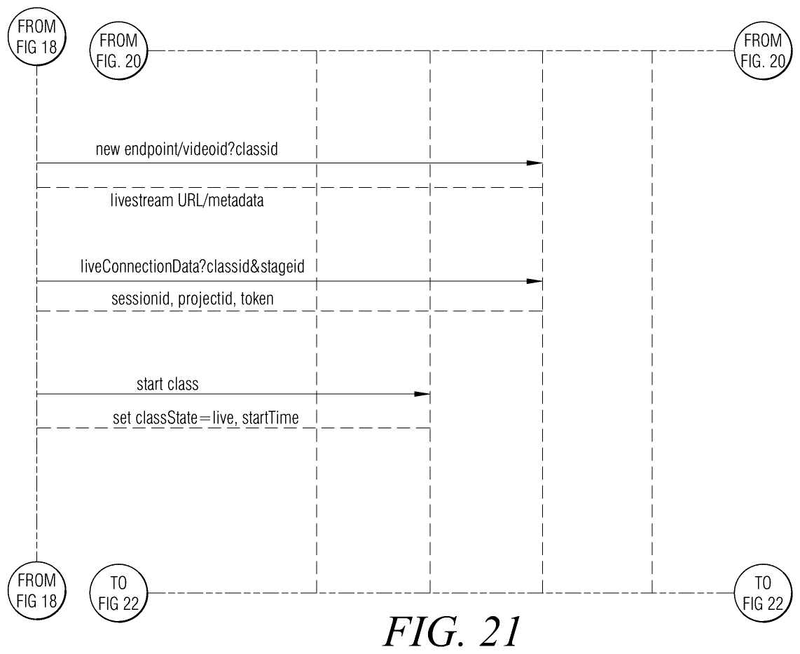

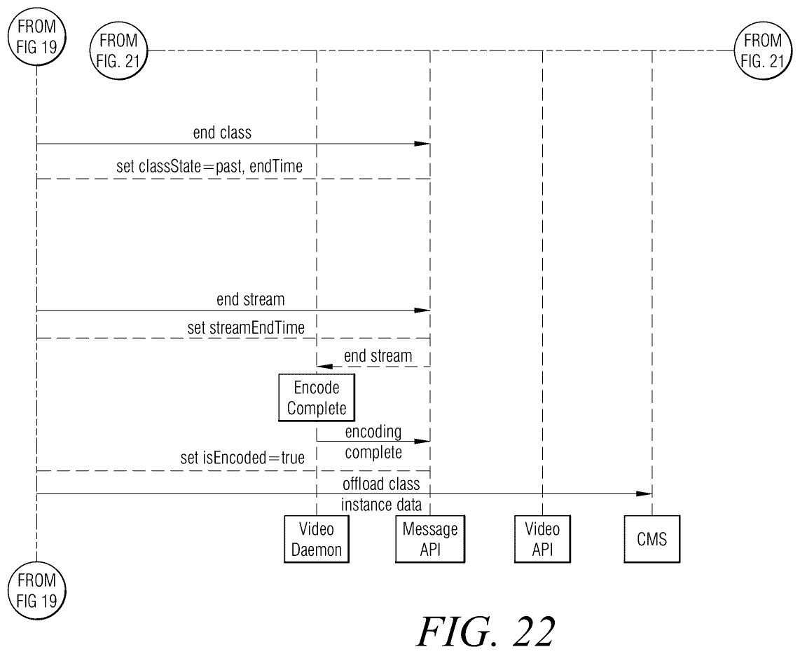

Similarly, FIGS. 17-22 illustrate a live class workflow used to implement one or more portions (or the entirety) of the BODCast wall shown in FIG. 1, the moderation tool and screens show in FIGS. 2-8, and/or the moderation control panel or tool shown in FIGS. 9 and 10.

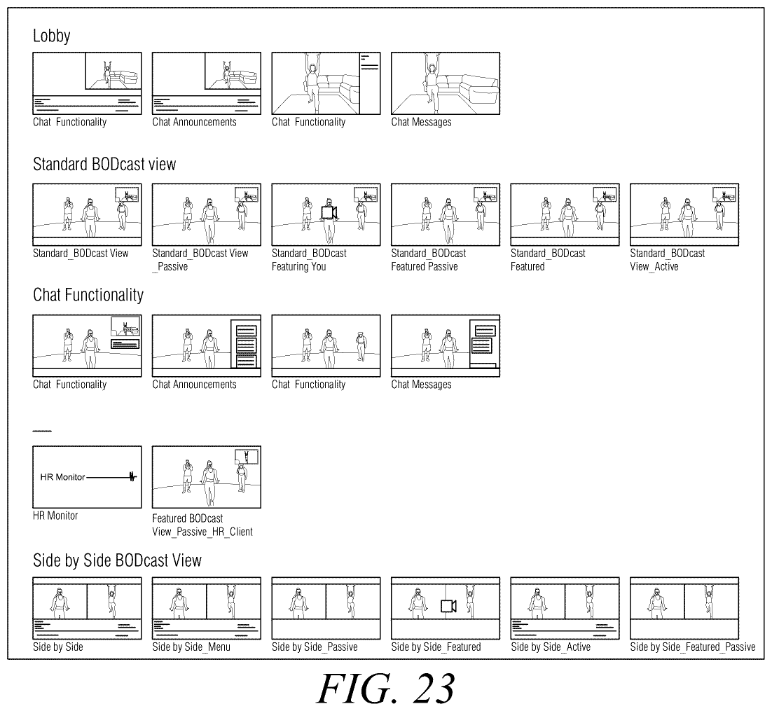

FIG. 23 illustrates a moderator control screen of the moderator tool that enable the moderator to view the number of participants and their identifier in each of the virtual rooms for each workout session. The virtual rooms can include the live workout session with the BODCast wall, the waiting room or lobby, and the chat room. Using the tool shown in FIG. 23, the moderator can select (drag & drop) any of the windows and drop it into another virtual room. Each window is a video stream session of a participant.

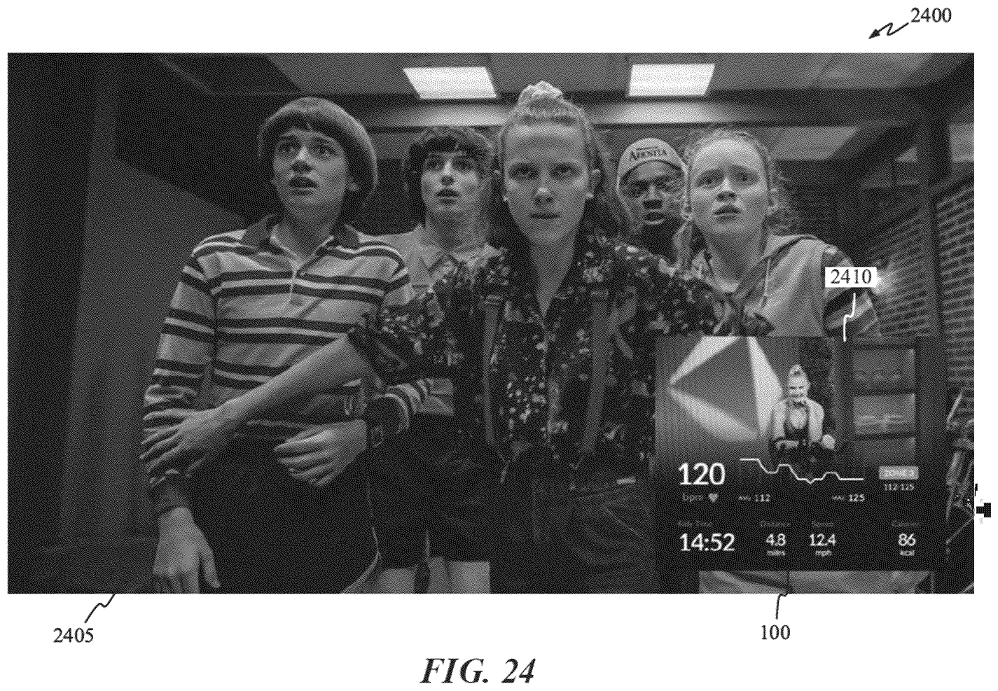

FIG. 24 illustrates a user display 2400 in accordance with some embodiments of the present disclosure. Display 2400 can be customized by the user, which can include a main video streaming window 2405, a workout session window 2410, and a workout performance metrics window 2415. The location of each of the windows can be swapped with each other and/or move to other location of display 2400. Workout session window 2410 can also be swapped with a selfie-window—video obtained from the participant's own camera. The main video window 2405 can be linked to a 3^{rd} party video streaming services such as Netflix, HULU, Amazon Prime Video, Disney+, etc.

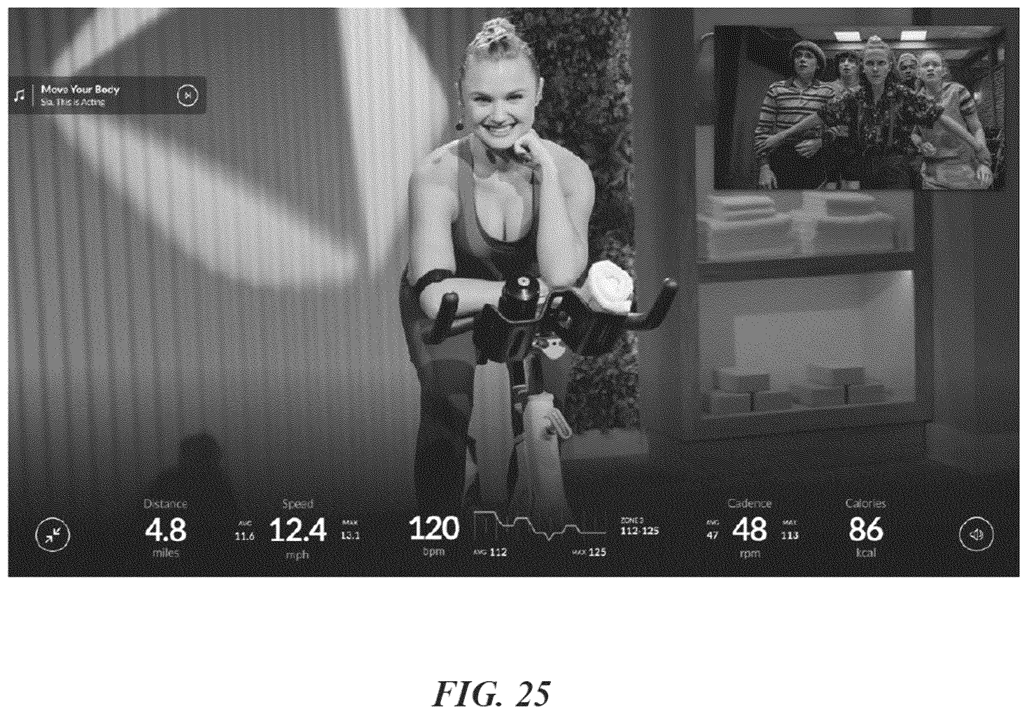

FIG. 25 illustrates user display 2400 where main window 2405 is made smaller and workout session window 2410 is now the main video window. Performance metrics window 2415 is now disposed along the bottom of display 2400. Performance metrics window 2415 can include performance metrics such as, but not limited to, distance biked, average speed, maximum speed, average heart rate, maximum heart rate, current heart zone, next heart zone, calorie burned, etc. Performance metrics window 2415 can also be disposed along one of the sides of display 2400.

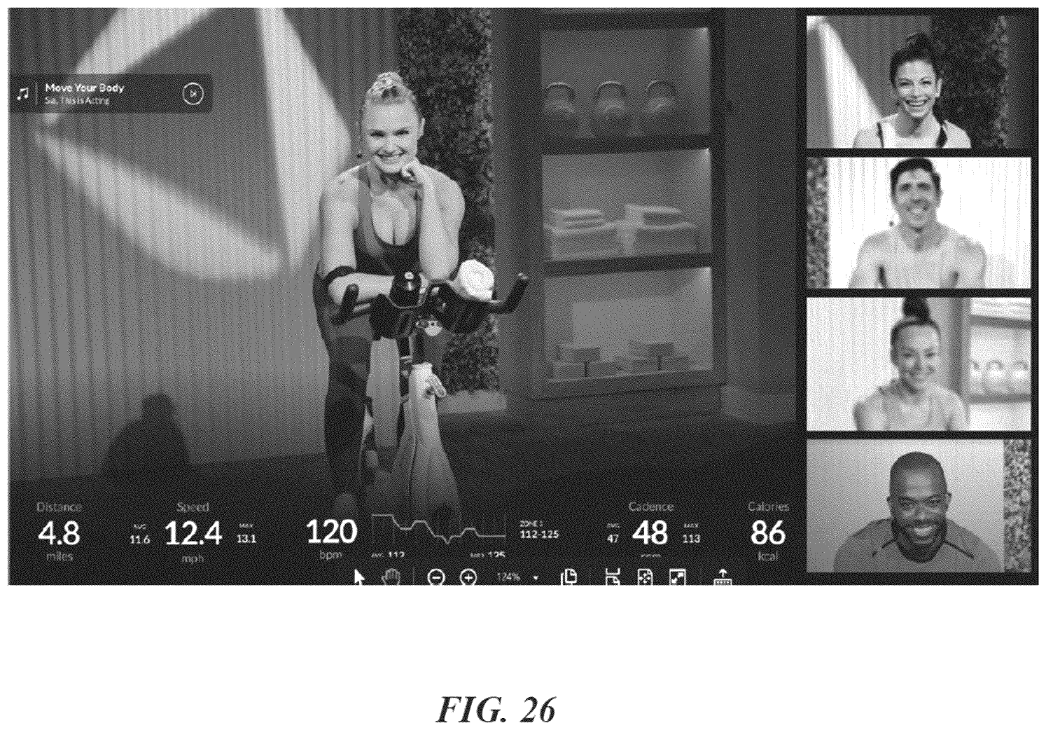

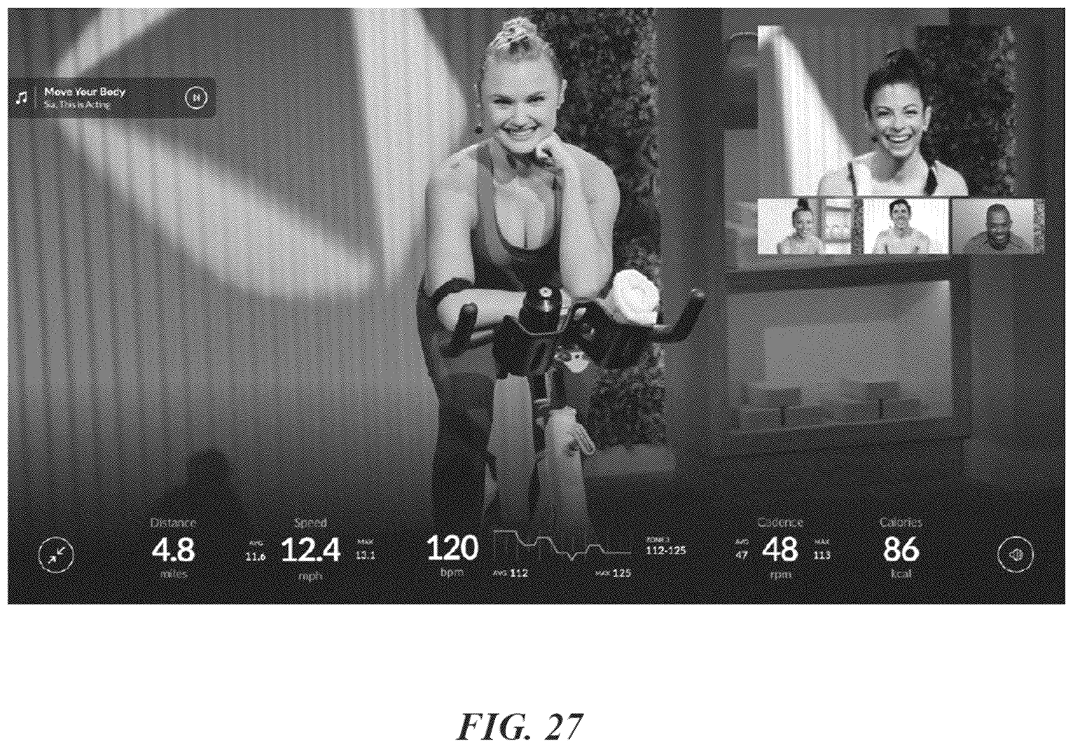

FIGS. 26-27 illustrates picture-in-picture (PIP) of friends and “selfie” video, obtained from the participant own camera, being displayed within main session window 2405. Each of the PIP windows can be resized or selected to enlarge. In some embodiments, the participant is able to select a friend's window to enlarge the friend's window, view the friend's performance metrics, or send a private message (text, audio, or video) to the friend. FIG. 27 illustrates one of the PIP windows enlarged and others arranged in different locations.

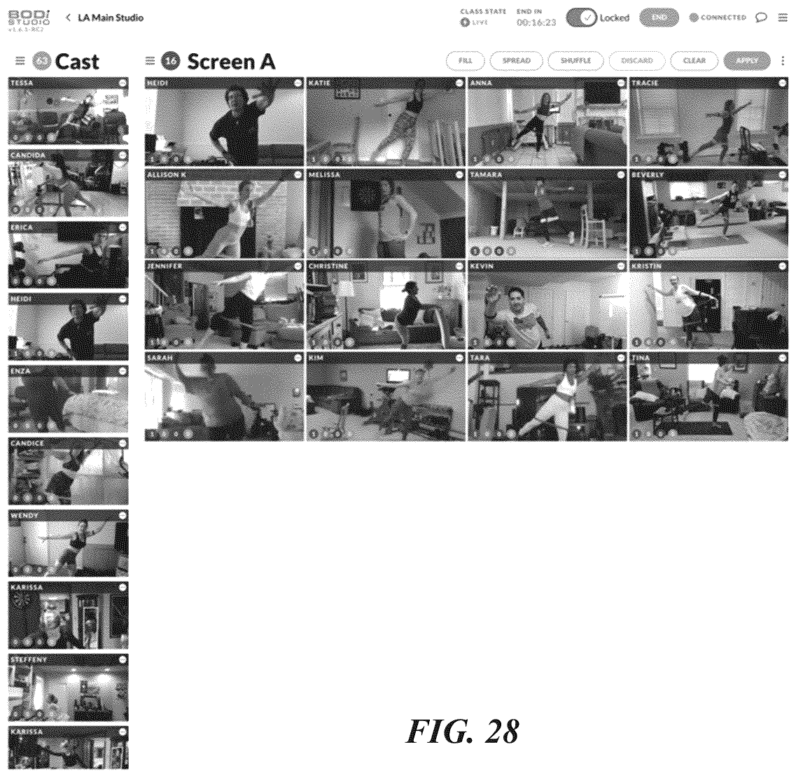

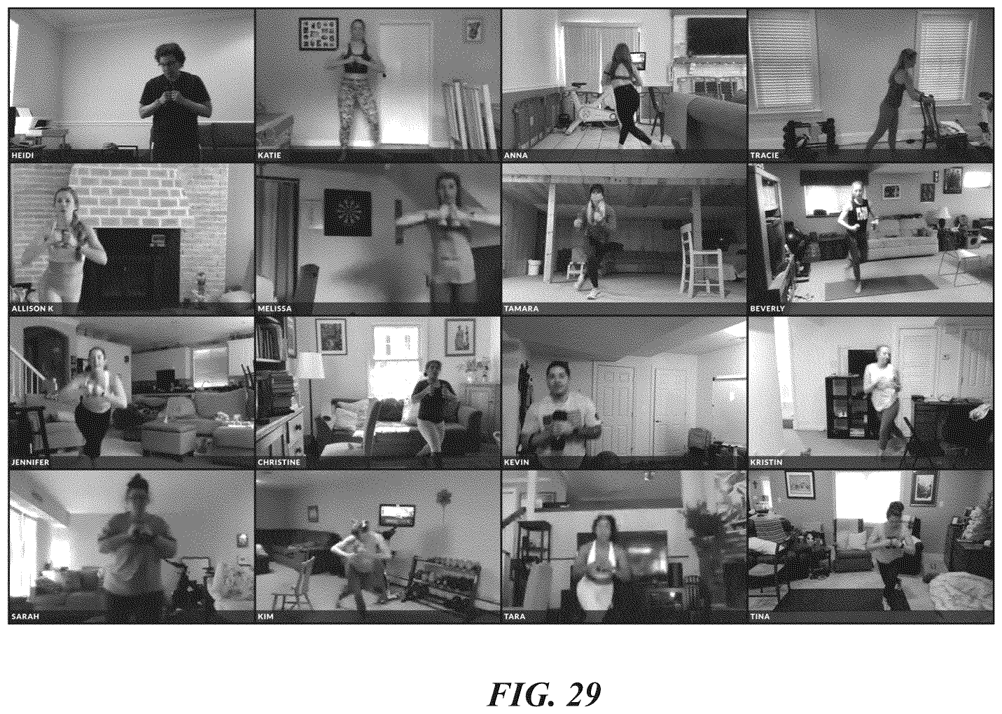

FIG. 28 illustrates an example of a number of people working out within a workout community in accordance with some embodiments of the present disclosure. FIG. 29 illustrates another example of a number of people working out within a workout community in accordance with some embodiments of the present disclosure. As illustrated in FIGS. 28-29, a number of different users may be available for displaying within a workout session. For example, the workout session may have a virtual wall of live streams, e.g., as illustrated in the example of FIG. 29. An example system may determine whether a plurality of participants (e.g., as illustrated in FIGS. 28-29) are eligible to be presented on a wall of live streams of a live workout session based at least on an eligibility criteria. A subset of the participants (including in some examples all participants) may be displayed on a video stream on the wall of live streams based on the determination.

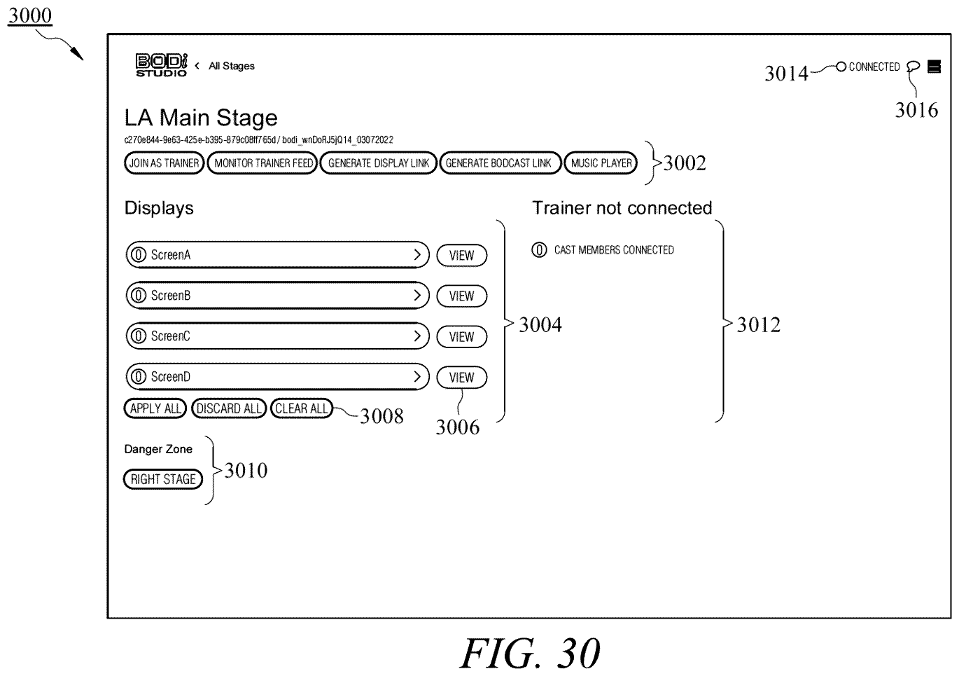

FIG. 30 illustrates an example of joining a stage in accordance with some embodiments of the present disclosure. In some embodiments, most of a user's testing in the BODi Studio Client may be though a class. Accordingly, the user may have access to all the functionality of the Studio Client. However, if the user is looking to do general testing around display configurations, BODCast connections, and moderator display tools, the user may do this simply by joining through a stage. An example Stage page 3000, e.g., a page for joining a stage, is illustrated in FIG. 30.

In an example embodiment, when the user is in a stage, the user may see the interface separated into several sections. The top row, containing connection buttons 3002 to join as a trainer, monitor a trainer, generate display links, generate a BODCast link, and the music player. The middle area 3004 may be where we find the Displays; here a user may modify the layout of the displays, assign users to screens, and then use the “View” button 3006 to see what the output looks like. Directly below the stages you will also see the options 3008 to “Clear All” displays, and the “Apply/Discard” options alongside the “Clear All” option. Continuing down, may be a button for the “Danger Zone” 3010. Because these buttons should not be used without understanding what they do, they may come with an alert pop-up that checks to determine if a user is moving through their actions too fast. The “Danger Zone” 3010 is discussed in more detail below.

In an example embodiment, on the bottom of the display (now shown if there are no Cast members connected) the moderator may be given a list of all Cast connections, along with a low-resolution video feed of each one.

In an example embodiment, to the right of these is where the trainer feed 3012 may be displayed. In an example, a user may not see any video there when no trainer has connected. Additionally, in an example, to the right of that in the top right corner, a connection status indicator 3014 may be given, with a chat icon 3016 directly to the right of that. In an example, the chat may be where moderators can send direct chats to an individual user, or an Announcement, which may go to all connected BODcast members. In an example, click on the Chat button 3016 to open up the chat window. To send a message to an individual, click “Chat” next to the user's name. To send an announcement to all members, click “Announcement” at the top of the chat window.

In an example embodiment, the connection buttons 3002 may be used to join as a Trainer/Monitor Trainer Feed. Open this in a new tab, and a user may begin the trainer feed. The trainer feed may be what the participants will see when the participants sign on. A user may also monitor the trainer feed using the button to the right of the “join as trainer” button. Note that in an example embodiment, the “monitor trainer feed” may be mirrored by comparison to what you see on the trainer feed, e.g., under “join as a trainer.” The trainer and monitor connections may both automatically connect. In an example embodiment, the need for a moderator to select “connect” by default is removed. When a connection is lost or cut off, the Connect button may be presented as an option.

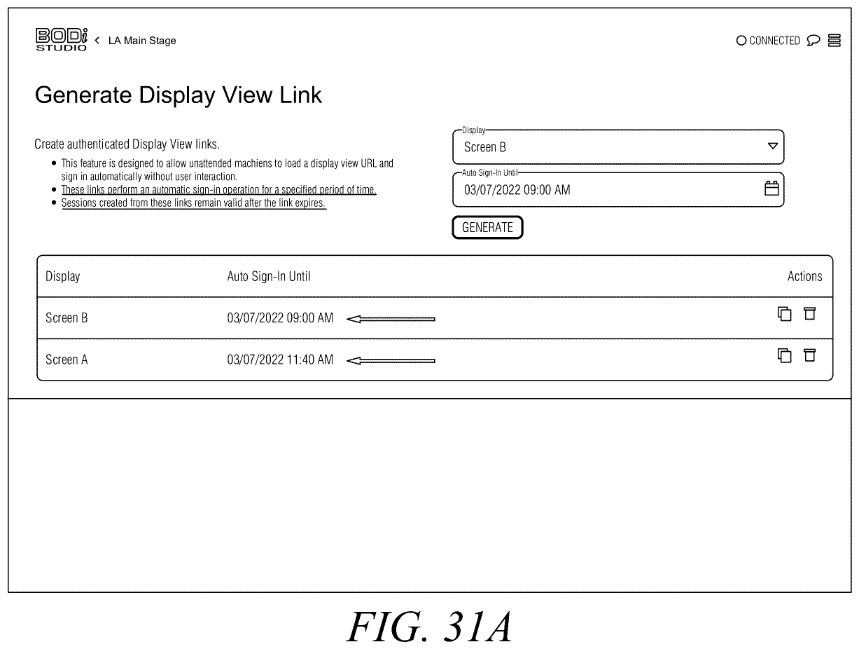

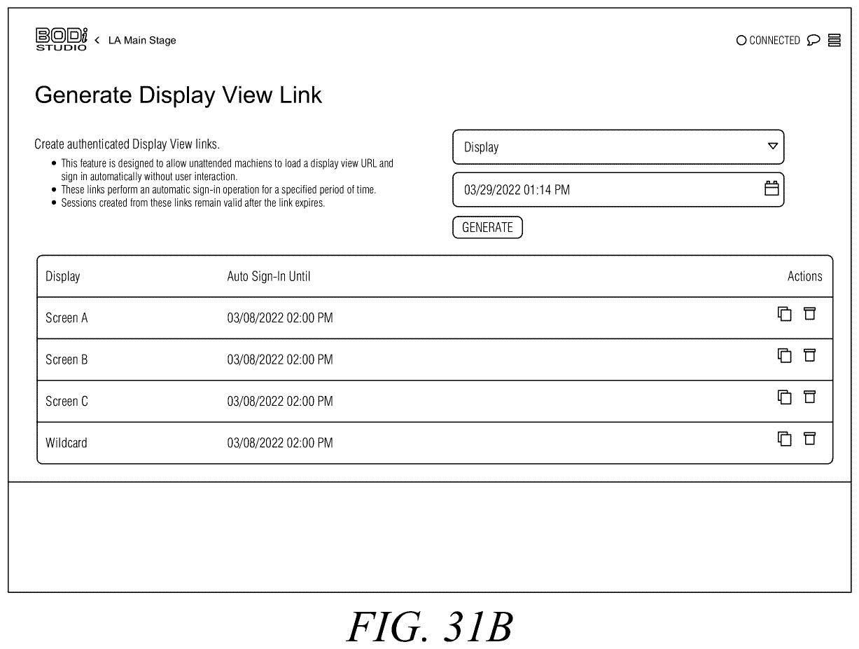

FIGS. 31A-31B illustrate generating display view links in accordance with some embodiments of the present disclosure. In an example embodiment, generating display view links may create authenticated Display View links. This feature may be designed to allow unattended machines to load a display view URL and sign in automatically without user interaction. These links perform an automatic sign-in operation for a specified period of time, and it is important to note Sessions created from these links remain valid after the link expires. Valid links may be displayed in black, while expired links may be displayed in red, in some example embodiments.

When generating a link and setting an expiration time (e.g., Auto Sign-In Until) this does not mean that the link is invalid after that time. When a machine has signed in using this link, the machine may continue to authenticate with that browser until the user of the machine invokes a clear cache or reset to the machine. In an example embodiment, this may remain valid for up to 30 days.

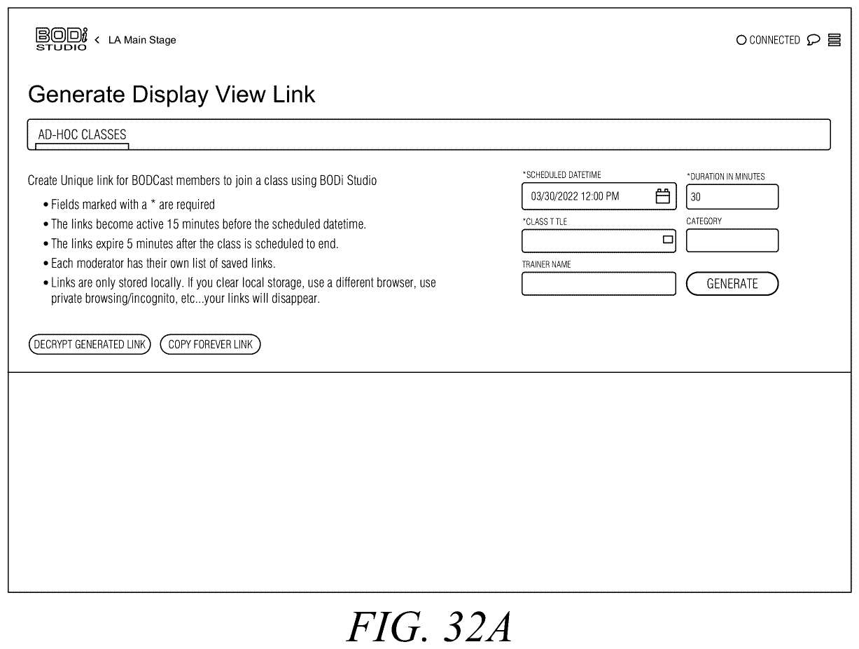

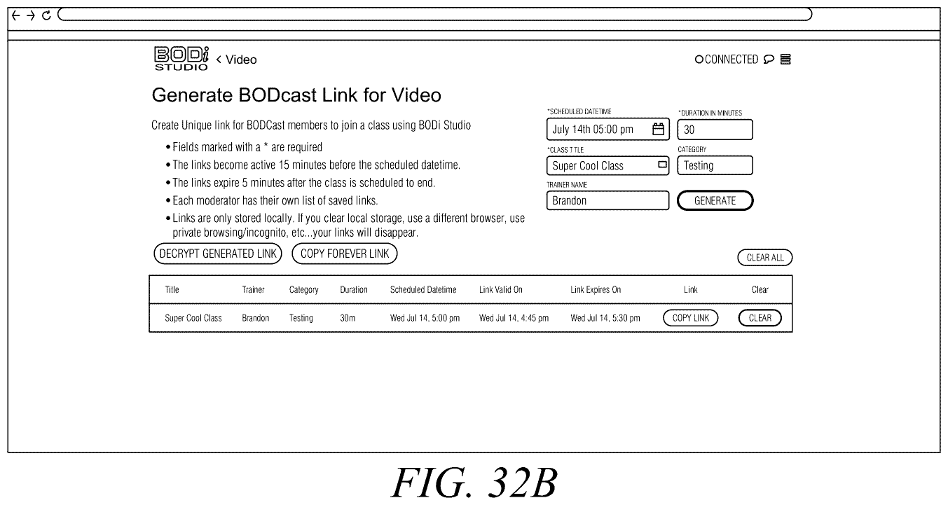

FIGS. 32A-32B illustrate generating BODcast links in accordance with some embodiments of the present disclosure. In the illustrated example, open this in a new tab, and you will see the BODcast link generation page. In here, a user may create ad-hoc encrypted links that are distributed and used for members/testers to join a class. Using the controls on the right side, you can set a link that starts at a specific time (note that an example embodiment may defaults to 1 day ahead, so when a user wants to be doing any imminent testing, the user may beed to be sure to change the date). Using these links, the user may see that other users are able to join a class up to 15 minutes before the start time, and up to 5 minutes after the end time. When you load this link, a user may see that the user may be asked to enter their display name, and below that they may see a message with a phone number for customer support. When the users try to use this link outside of the allowed time window, they will not be allowed to join, and a message stating when the class will start, or that the class has already taken place and is now closed may be displayed in some example embodiments.

For testing purposes, a user may want to generate a “forever link” which has no time constraints for joining and clicking “Copy Forever Link” may give you this encrypted link for a 30-minute class in an example embodiment. Note that all links are encrypted, and you can decrypt the link using the button to the left of the “forever link” button.

FIGS. 32A-32B illustrate a music player in accordance with some embodiments of the present disclosure. An example embodiment of a music player may use three different types of music in our BODi classes. First Play, which may be a curated playlist provided by the trainer that may be synced for everyone that joins the Live class before the music start time (e.g., ˜1 minute into class), FeedFM Template, which may be a genre-defined template station hosted by a Feed, Sync Music, music embedded into a class.

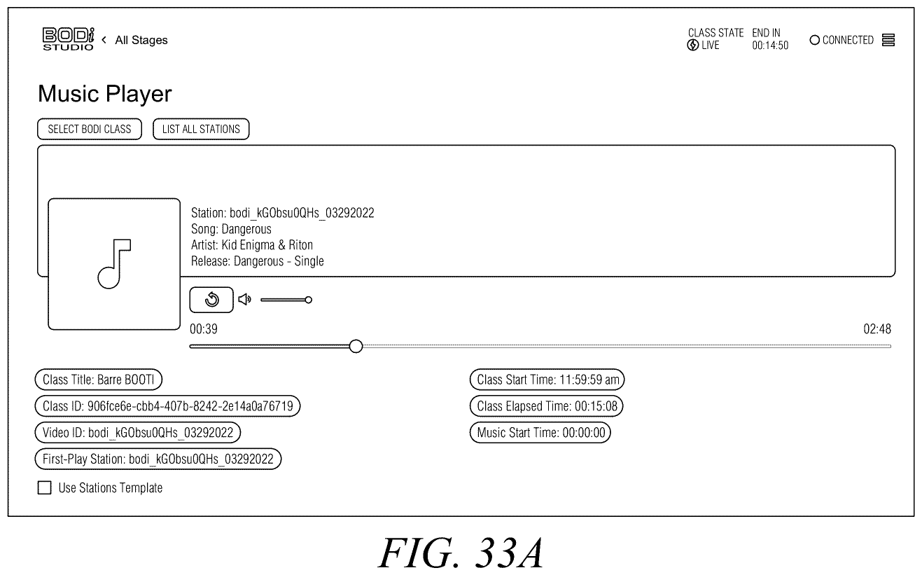

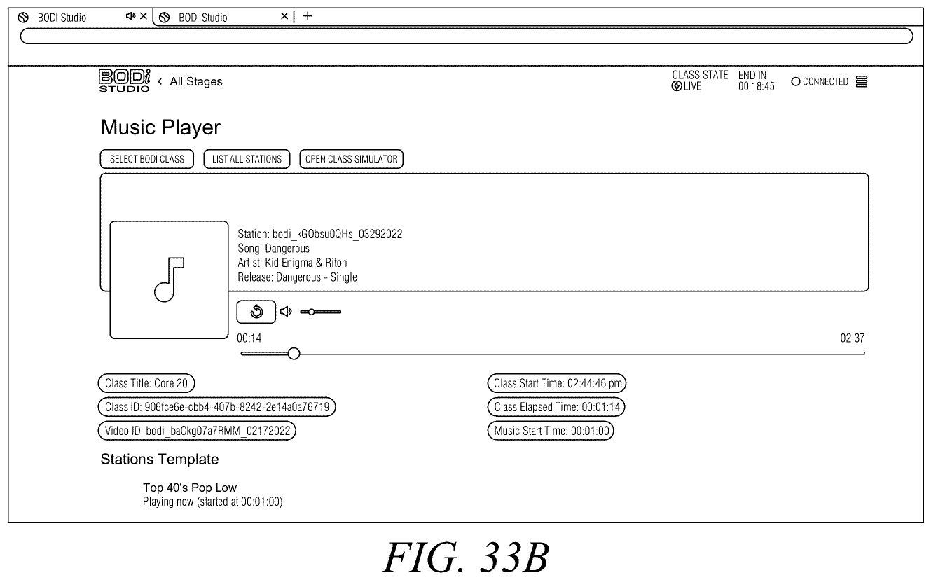

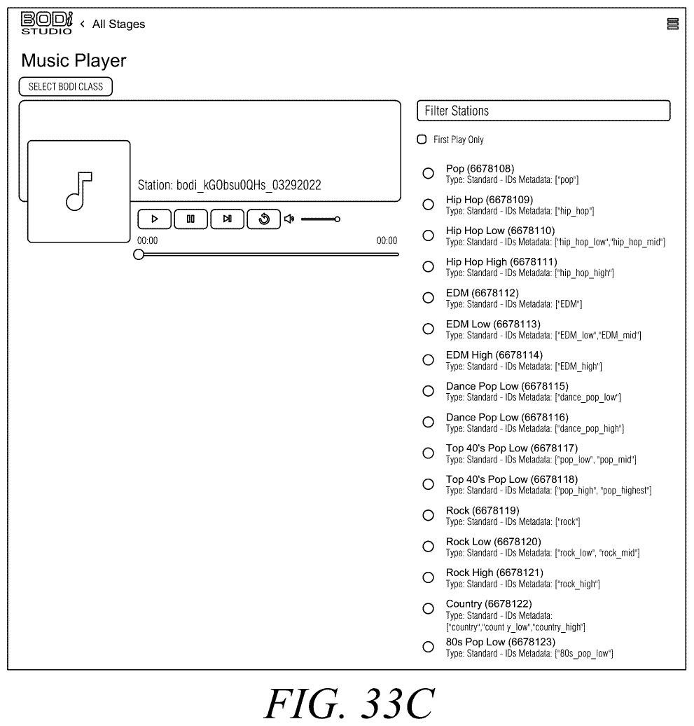

FIGS. 33A-33C illustrate example interfaces for a FeedFM Template class in accordance with some embodiments of the present disclosure. An example may allow a user to see the current track playing, a progress bar, volume controls, and metadata for the class. On the left side under the progress bar we can see the ClassID and VideoID; we use VideoID in Feed to identify playlists. If the class is equipped with a FirstPlay playlist, the class may be identified as such. If the class is using Sync music, the player may still show progress in the class, but a yellow box may be displayed above the player saying that with Sync music, no music playback is to be expected in the player itself. On the right side underneath the progress bar a user may see Class Elapsed Time, as well as Music Start Time. Thanks to changes in the Studio Client. Additionally, an example embodiment may have the ability to “drop in” with a First Play playlist. If the player is not opened on time for any reason, or the page needs to be refreshed, the user may load the player and hear playback from the point in class that the FP playlist is supposed to be at.

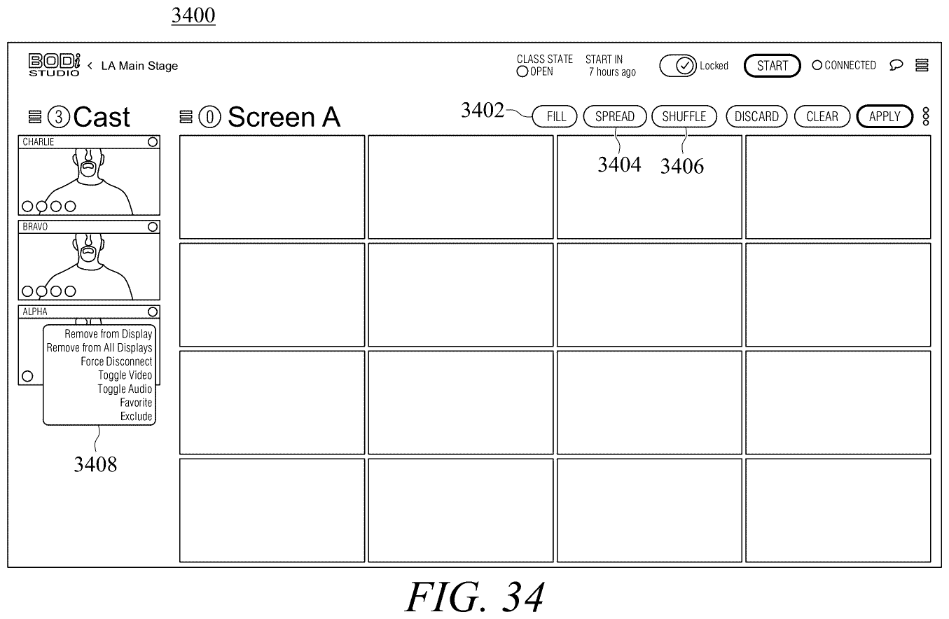

FIG. 34 illustrates an example display and configure options screen 3400 in accordance with some embodiments of the present disclosure. In the display section, moderators may have the ability to populate display grids with Cast member feeds, modify layouts, and disconnect users. A user may see the name of the display you are configuring above the top left corner of the grid. Cast members that are connected may be to the left of the grid and may be added to the display using “Fill” 3402 or “Spread” 3404. At the end of the control button row, a user may see a triple-dot control. Clicking this may access the display output configuration controls. A user may see that the maximum number of row inputs and/or column inputs may be 20, and any input above 20 may default to the maximum of 20 (or some other maximum number, e.g., 1-40 or more). Note that in some examples, changes do not take place in the display until you click “Apply.”

In an example embodiment, the fill button, “Fill,” 3402 may fill all empty tiles on a display. If the display grid is empty, this will fill every tile, and will appear the same as using “Spread” 3404. However, in some examples, the difference between Fill and Spread may be that if there were already tiles populated by Cast members, the Fill button will preserve those tiles and only fill empty tiles. Using this feature, a user may expect the empty tile(s) to be filled in order starting with the least used Cast member on the Cast list, and then by order of most-to-least recent joined (e.g., top to bottom). The spread button, “Spread” 3404 may be used to fill all tiles on a display grid and may not preserve any pre-populated tiles. The shuffle button, “Shuffle” 3406 may populate tiles on a display that are shuffled. In an example, no new users are brought in.

If a user has made changes to a Display Grid but decide that they do not want to apply these changes, the user may simply click “DISCARD” and no changes will be applied. Once Cast members are added to the display, a user may clear all video tiles by clicking “CLEAR.” Additional controls may be accessed through Individual Video Controls for Cast members by clicking the triple-dot menu on their video feed, covered in item 3408. The context menu for the Cast member contains the following items:

Remove from Displays: if done on the display grid, this will remove a Cast member from that one instance in the display grid. If done on the Cast list, this will remove them from that display entirely. Remove from All Displays: clicking this anywhere (grid or list) will remove all instances of the Cast member. Force Disconnect: this will disconnect the Cast member from the class but does not prevent them from rejoining the class. Toggle Video: toggles the video feed of the Cast member on or off in the studio. Toggle Audio: to turn audio on and off. Favorite: gives preference to the Cast member(s) when Filling or Spreading onto a display. Exclude: prevents the Cast member from being selected during Fill or Spread operations.

When returning to the main moderator page, a user may notice the option below the displays to “Clear All”; in an example embodiment, this button may clear all participants from the displays, will not disconnect participants, and will not affect the trainer feed (they should stay connected). Be sure to click Apply All to make the changes take hold; click Discard All to revoke changes.

An example may include a “danger zone.” A Reset Stage may be a button that refreshes the Tokbox session ID, disconnects the trainer and all Cast members, and clears all Displays. In an example embodiment, when clicked the user may see an alert saying, “Are you sure? If you continue, the trainer and all BODcast members will be disconnected” (or some other warning message). In an example embodiment, a validator of expected behavior should include seeing the blue link below the stage name being updated, displays may be emptied, and a brief disconnect/reconnect may be confirmed by the indicator in the upper right corner (e.g., it will turn orange and say “Connecting,” then turn green once connected again). In an example embodiment, this button may be a combination of our previous two separate buttons, “Renew Session ID” and “Clear the Stage.”

Example embodiments may allow for joining a class. Checking behavior of the moderator tool while in a class may be done by clicking on a class listed in the main page. An Upcoming class should have data such as what time it starts, class name, duration, stage name, which music feed is to be used, and an “Enter” button to the right. Click “Enter” to be brought to the moderator page for that class. A user may notice that when you enter a class, you now have access to class state buttons located in the header control bar, and the moderator can move a class through six states: (1) Upcoming, (2) Open, (3) Live, (4) Past, (5) Closed, and (6) Encoded.

In an example embodiment, the state change button may be disabled until a user unlock the state change button, e.g., using the toggle. In an example embodiment, a user may only be allowed to make one state change per unlock. In an example embodiment, a user may see the state change occur, and then verify that the class state has changed by returning to the main page and seeing that the class has gone from “Upcoming” to “Open”, if you selected an Upcoming class.

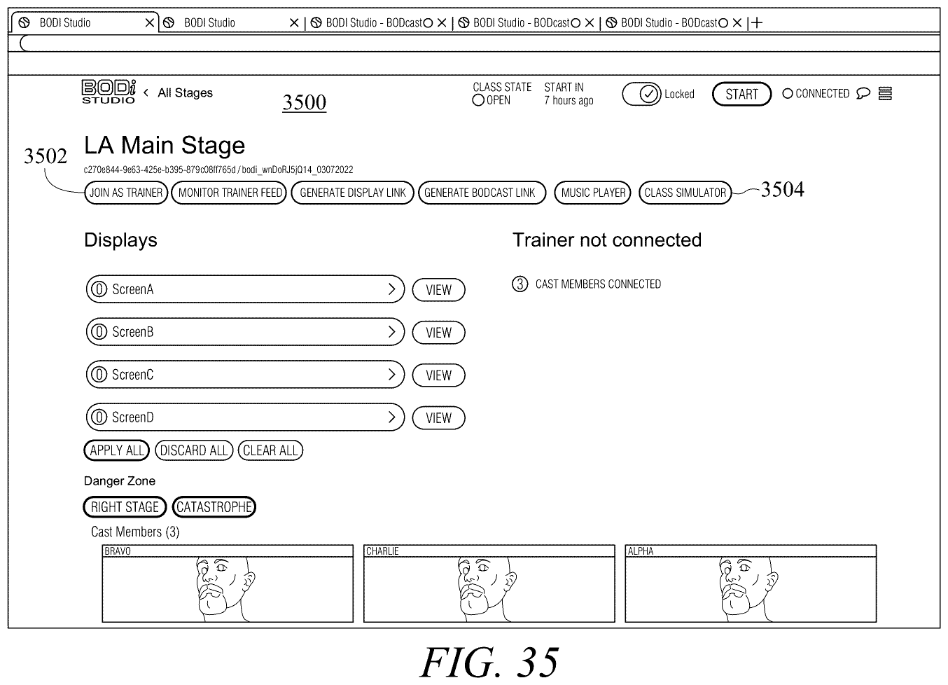

FIG. 35 illustrate example screen 3500 for connection buttons in a class in accordance with some embodiments of the present disclosure. Once a user has entered a scheduled class, the user may see an expanded selection of connection buttons 3502. In an example, a button 3504, may be titled “CLASS SIMULATOR.” The class simulator has been added as a testing tool, allowing users to take a class and simulate running the class through an entire life cycle without actually effecting the state of the class. Simulating may allow users to not only check the states, but also playlists, timers, UI changes, and connectivity validations.

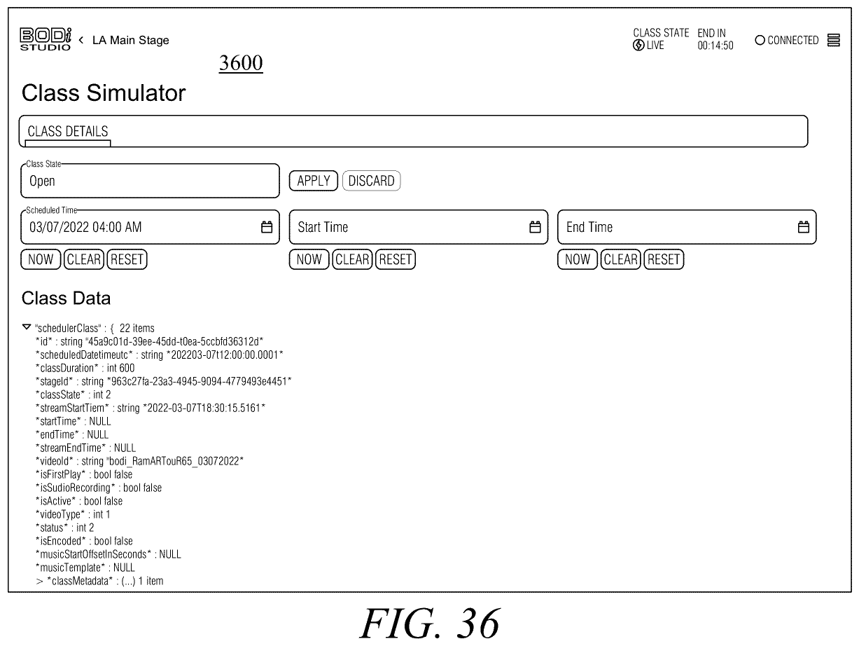

FIG. 36 illustrate example screen 3600 for a class simulator in accordance with some embodiments of the present disclosure. Testing for the simulator tool may be done by following these steps to bring a class through the class lifecycle. In an example embodiment, first, navigate through a class on the schedule, generate a BODCast link for that class and open in a new tab (e.g., using the BODi Class link in the blue header bar, not Ad-Hoc Classes). Open the Class Simulator, observe that the state is Upcoming; change the state to Open, with a Scheduled Time e.g., ˜10 minutes ahead of current time. Click Apply, and the user will be able to join the class and see a countdown to class. Change the class state to Live, and apply a Start Time of Now, and observe that the Cast member begins class. All Class Data is shown in the Simulator page, for reference during testing (of note, check music start time to confirm accuracy). Change the state to Past, and click Apply, and the Cast member should enter the Past state. Music stops, and the timer also stops. Once you have moved a class through its live cycle, refresh the page to reset to the class's current, non-simulated state.

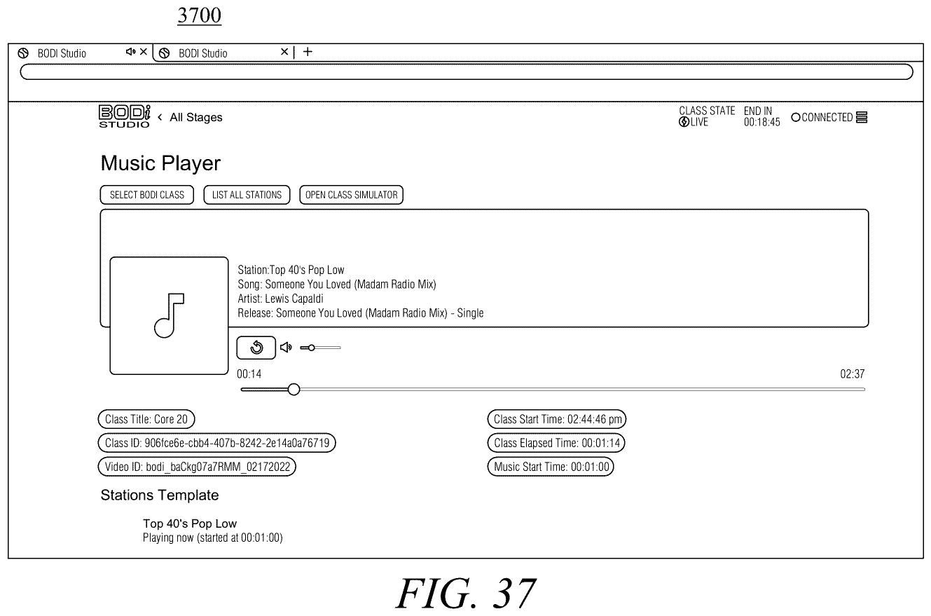

FIG. 37 illustrate example screen 3700 for using the music player and class simulator in accordance with some embodiments of the present disclosure. In an example embodiment, basic functionality of the Music Player was covered in an earlier section, and I mentioned that we have integrated the ability to drop into a First Play playlist; what this means is if the player was opened late for any reason, or the connection has to be reset during a class, we are able to load this player and the music will start at the expected point of a First Play playlist, not from the beginning or defaulting to a Template station.

In an example embodiment, to organically see this function in action, log into Studio Client, and enter a class with valid First Play playlist attached to it. Move the class to Live, and let the class run for 2 minutes. Then open the Music Player; this should organically show you how the FP Drop-In feature works.

In an example embodiment, some buttons should not be used lightly unless fully understood. A catastrophic event could include, but is not limited to, something such as an electrical fire in the studio, or a trainer experiencing a medical event. Clicking the Catastrophe button may display the following alert, in some examples: “Are you sure? If you continue, the trainer and all BODcast members will be disconnected, the livestream will be cut, the video encoding process will be aborted, and the class will be removed from the schedule. ONLY CONTINUE IF YOU KNOW WHAT YOU'RE DOING AND A CATASTROPHIC EVENT HAS OCCURRED.” It will be understood that other alerts are possible in other embodiments. Should you choose to continue, one more alert will ask you: “Are you REALLY sure? Do not click OK if you're not 100% sure.” It will be understood that other alerts are possible in other embodiments. Clicking OK once more may trigger the Catastrophe event, and a message will be sent to the Cast members letting them know that the class was ended. This may be verified by looking in the Network tab when the event is triggered, and you will see the post request showing the message was sent.

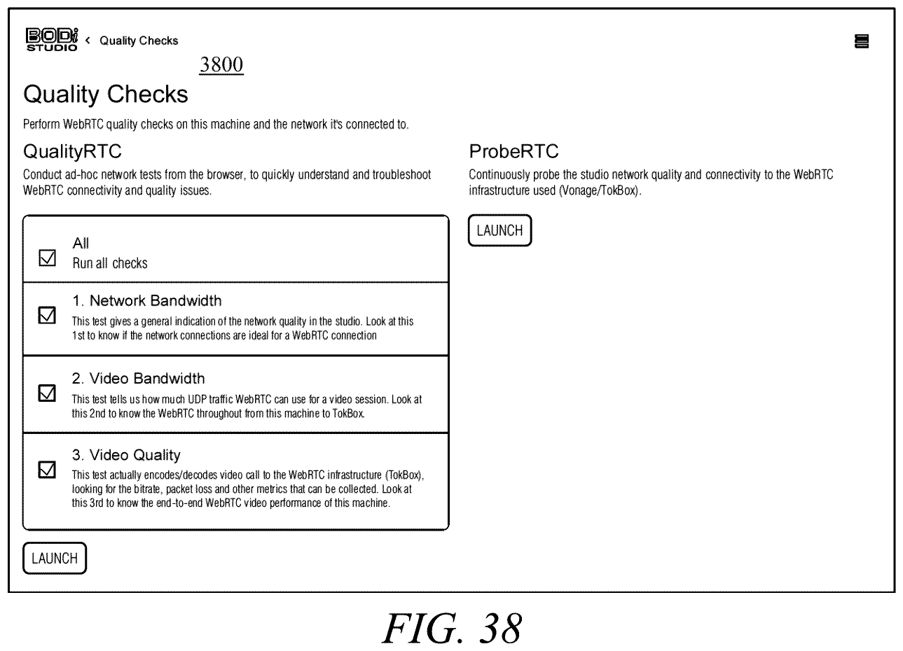

FIG. 38 illustrate example screen for quality checks in accordance with some embodiments of the present disclosure. The quality checks screen may be used to perform quality checks on the machine and the network and The network's connectivity. In an example embodiment, this selection screen may include a number of choices for which quality checks to be performed. For example selecting “ALL” may run all checks. Other possibilities may include checks on network bandwidth, checks on video bandwidth, and checks on video quality. In the illustrated example each of these checks may be selected individually.

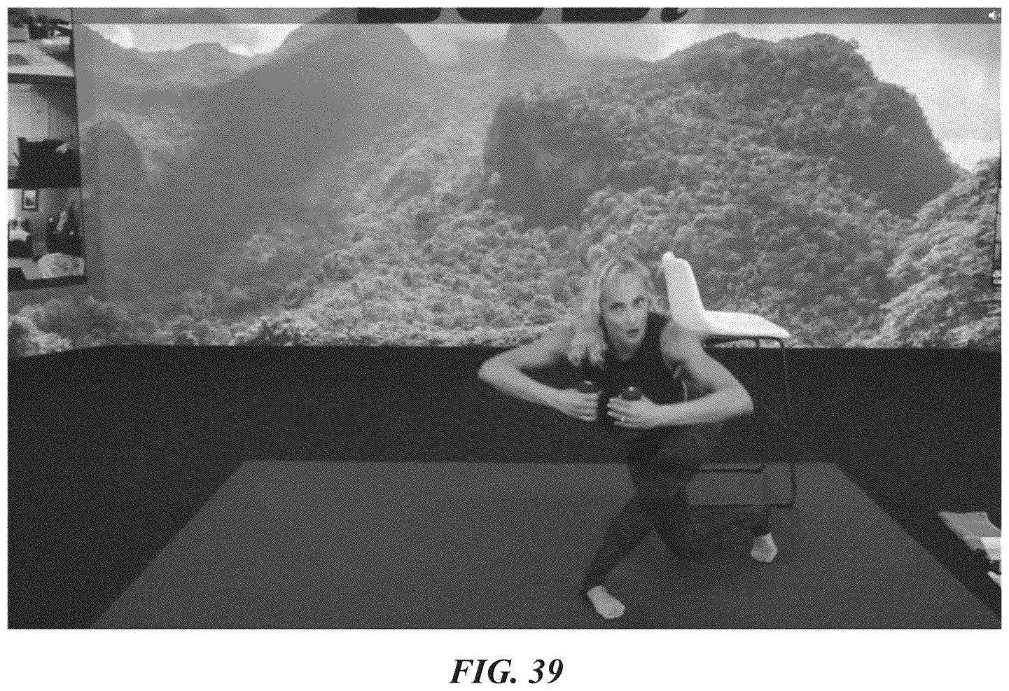

FIG. 39 illustrate example of a workout using dumbbells in accordance with some embodiments of the present disclosure. The systems and methods described herein may be applied to various types of workouts that maybe viewed on a monitor and may be broadcast by multiple users on a video wall. The illustrated example shows a dumbbell workout. other example workouts may include stationary bicycles, elliptical machines, stair climbers, or any other appropriate machine or exercise apparatus. As illustrated in the example of FIG. 39, not all workouts require an exercise machine, some may use weights or other devices.

An example embodiment may include systems and methods for displaying a workout session. For example, the method may include determining whether a plurality of participants are eligible to be presented on a wall of live streams of a live workout session based at least on an eligibility criteria, and displaying a video stream of a first participant from the plurality of participants on the wall of live streams based on the determination.

In an example embodiment, the eligibility criteria may include one or more performance metrics. In another example embodiment, the eligibility criteria may include one or more previous performance metrics. In an example embodiment, the eligibility criteria may include a community score of each of the plurality of participants. Accordingly, determining whether a plurality of participants are eligible to be presented on a wall of live streams of a live workout session may include comparing one of these to a predetermined metric to determine eligibility or comparing participants against each other to fill a predetermined number of spots on the wall. Displaying a video stream may include transmitting a selected video stream to a device and the device converting the transmitted signal to a video image.

In an example embodiment, the method may further include monitoring the video stream of the first participant to detect inappropriate activity and removing the video stream of the first participant from the wall of live streams based on detection of inappropriate activity.

In an example embodiment, the monitoring to detect inappropriate activity may include analyzing, using one or more AI-engines, the video stream of the first participant to identify and classify inappropriate attire.

In an example embodiment, the monitoring to detect inappropriate activity may include analyzing, using one or more AI-engines, the video stream of the first participant to identify and classify inappropriate images in the background of the participant's video.

In an example embodiment, the monitoring to detect inappropriate activity may include analyzing, using one or more AI-engines, the video stream of the first participant to identify and classify inappropriate gestures.

In an example embodiment, the wall of live streams comprises a plurality of live streams of participants at various remote locations.

### CONCLUSION

The embodiments described above are considered novel over the prior art and are considered critical to the operation of at least one aspect of the disclosure and to the achievement of the above-described objectives. The words used in this specification to describe the instant embodiments are to be understood not only in the sense of their commonly defined meanings, but to include by special definition in this specification: structure, material or acts beyond the scope of the commonly defined meanings. Thus, if an element can be understood in the context of this specification as including more than one meaning, then its use must be understood as being generic to all possible meanings supported by the specification and by the word or words describing the element.

The definitions of the words or drawing elements described above are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

In the foregoing description and in the figures, like elements are identified with like reference numerals. The use of “e.g.,” “etc,” and “or” indicates non-exclusive alternatives without limitation, unless otherwise noted. The use of “including” or “includes” means “including, but not limited to,” or “includes, but not limited to,” unless otherwise noted.

As used above, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, processes, operations, values, and the like.

1. A method displaying a workout session, the method comprising:
determining whether a plurality of participants are eligible to be presented on a wall of live streams of a live workout session based at least on an eligibility criteria;
displaying a video stream of a first participant from the plurality of participants on the wall of live streams based on the determination.

2. The method of claim 1, wherein the eligibility criteria comprise one or more performance metrics.

3. The method of claim 1, wherein the eligibility criteria comprise one or more previous performance metrics.

4. The method of claim 1, wherein the eligibility criteria comprise a community score of each of the plurality of participants.

5. The method of claim 1, further comprising:
monitoring the video stream of the first participant to detect inappropriate activity; and
removing the video stream of the first participant from the wall of live streams based on detection of inappropriate activity.

6. The method of claim 5, wherein monitoring to detect inappropriate activity comprises analyzing, using one or more AI-engines, the video stream of the first participant to identify and classify inappropriate attire.

7. The method of claim 5, wherein monitoring to detect inappropriate activity comprises analyzing, using one or more AI-engines, the video stream of the first participant to identify and classify inappropriate images in the background of the participant's video.

8. The method of claim 5, wherein monitoring to detect inappropriate activity comprises analyzing, using one or more AI-engines, the video stream of the first participant to identify and classify inappropriate gestures.

9. The method of claim 1, wherein the wall of live streams comprises a plurality of live streams of participants at various remote locations.

10. A system for displaying a workout session having a virtual wall of live streams, the system comprising:
one or more processors;
a memory coupled to the one or more processors, the memory having instructions that when executed cause the one or more processor to:
determine whether a plurality of participants are eligible to be presented on a wall of live streams of a live workout session based at least on an eligibility criteria;
display a video stream of a first participant from the plurality of participants on the wall of live streams based on the determination.

11. The system of claim 10, wherein the eligibility criteria comprise one or more performance metrics.

12. The system of claim 10, wherein the eligibility criteria comprise one or more previous performance metrics.

13. The system of claim 10, wherein the eligibility criteria comprise a community score of each of the plurality of participants.

14. The system of claim 10, wherein the instructions is further configured to cause the one or more processors to:
monitor the video stream of the first participant to detect inappropriate activity; and
remove the video stream of the first participant from the wall of live streams based on detection of inappropriate activity.

15. The system of claim 14, wherein the instruction to detect inappropriate activity comprises instructions to analyze, using one or more AI-engines, the video stream of the first participant to identify and classify inappropriate attire.

16. The method of claim 15, wherein the instruction to detect inappropriate activity comprises instructions to analyze, using one or more AI-engines, the video stream of the first participant to identify and classify inappropriate images in the background of the participant's video.

17. The method of claim 15, wherein the instruction to detect inappropriate activity comprises instructions to analyze, using one or more AI-engines, the video stream of the first participant to identify and classify inappropriate gestures.
